(19) United States
(12) Patent Application Publication
(10) Pub. No.: US 2025/0253906 A1
(43) Pub. Date: Aug. 7, 2025

(54) TRANSMISSION CONFIGURATION INDICATOR (TCI) STATE COMMUNICATIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Hamed PEZESHKI, San Diego, CA (US)

(21) Appl. No.: 18/855,633

(22) PCT Filed: Jun. 24, 2022
(86) PCT No.: PCT/CN2022/101027

§ 371 Date: Oct. 9, 2024

(51) Int. Cl. H04B 7/06

(52) U.S. Cl. CPC H04B 7/0626; H04B 7/06952

(57) ABSTRACT

Certain aspects are directed to a method for providing a wireless node with an indication of predicted future TCI states to be associated with a channel state information reference signal (CSI-RS). The wireless node may then perform a beam forming operation to determine an appropriate beam for receiving the CSI-RS based on the future TCI state. Thus, when the wireless node receives a command to switch to the future TCI state, the wireless node does not need to perform another beamforming operation.

### BACKGROUND

### Technical Field

The present disclosure generally relates to communication systems, and more particularly, to apparatus, methods, and techniques for communicating predicted transmission configuration indicator (TCI) states and TCI state change commands.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communications. In some examples, the apparatus includes a memory comprising instructions, and one or more processors configured to execute the instructions. In some examples, the apparatus if configured to obtain, from a wireless node, a first channel state information reference signal (CSI-RS) associated with a first transmission configuration indicator (TCI) state. In some examples, the apparatus if configured to obtain from the wireless node, an indication of one or more TCI states associated with the first CSI-RS to be obtained, wherein the one or more TCI states comprise a second TCI state; perform a beam adjustment based on the second TCI state to determine a beam; and obtain the first CSI-RS via the beam.

Certain aspects are directed to an apparatus for wireless communications. In some examples, the apparatus includes a memory comprising instructions and one or more processors configured to execute the instructions. In some examples, the apparatus is configured to obtain, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In some examples, the apparatus is configured to obtain, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to an apparatus for wireless communications. In some examples, the apparatus includes a memory comprising instructions and one or more processors configured to execute the instructions. In some examples, the apparatus is configured to output, for transmission to a wireless node, a first channel state information reference signal (CSI-RS) associated with a first transmission configuration indicator (TCI) state. In some examples, the apparatus is configured to output, for transmission to the wireless node, an indication of one or more TCI states associated with the first CSI-RS to be obtained, wherein the one or more TCI states comprise a second TCI state associated with the first CSI-RS. In some examples, the apparatus is configured to output, for transmission to the wireless node, the first CSI-RS via a beam associated with the second TCI state

Certain aspects are directed to an apparatus for wireless communications. In some examples the apparatus includes a memory comprising instructions and one or more processors configured to execute the instructions. In some examples, the apparatus is configured to output, for transmission to a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In some examples, the apparatus is configured to output, for transmission to the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to a method for wireless communications at a first wireless node. In certain aspects, the method includes obtaining, from a second wireless node, a first channel state information reference signal (CSI-RS) associated with a first transmission configuration indicator (TCI) state. In certain aspects, the method includes obtaining, from the second wireless node, an indication of one or more TCI states associated with the first CSI-RS to be obtained, wherein the one or more TCI states comprise a second TCI state. In certain aspects, the method includes performing a beam adjustment based on the second TCI state to determine a beam. In certain aspects, the method includes obtaining the first CSI-RS via the beam.

Certain aspects are directed to method for wireless communications at a user equipment (UE). In certain aspects, the method includes obtaining, from a network node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the method includes obtaining, from the network node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to a method for wireless communications at a first wireless node. In certain aspects, the method includes outputting, for transmission to a second wireless node, a first channel state information reference signal (CSI-RS) associated with a first transmission configuration indicator (TCI) state. In certain aspects, the method includes outputting, for transmission to the second wireless node, an indication of one or more TCI states associated with the first CSI-RS to be obtained, wherein the one or more TCI states comprise a second TCI state associated with the first CSI-RS. In certain aspects, the method includes outputting, for transmission to the second wireless node, the first CSI-RS via a beam associated with the second TCI state.

Certain aspects are directed to a method for wireless communications at a network node. In some examples, the method includes outputting, for transmission to a user equipment (UE), a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the method includes outputting, for transmission to the UE, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to an apparatus for wireless communications. In certain aspects, the apparatus includes means for obtaining, from a second wireless node, a first channel state information reference signal (CSI-RS) associated with a first transmission configuration indicator (TCI) state. In certain aspects, the apparatus includes means for obtaining, from the second wireless node, an indication of one or more TCI states associated with the first CSI-RS to be obtained, wherein the one or more TCI states comprise a second TCI state. In certain aspects, the apparatus includes means for performing a beam adjustment based on the second TCI state to determine a beam. In certain aspects, the apparatus includes means for obtaining the first CSI-RS via the beam.

Certain aspects are directed to an apparatus for wireless communications. In certain aspects, the apparatus includes means for obtaining, from a network node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the apparatus includes means for obtaining, from the network node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to an apparatus for wireless communications. In certain aspects, the apparatus includes means for outputting, for transmission to a second wireless node, a first channel state information reference signal (CSI-RS) associated with a first transmission configuration indicator (TCI) state. In certain aspects, the apparatus includes means for outputting, for transmission to the second wireless node, an indication of one or more TCI states associated with the first CSI-RS to be obtained, wherein the one or more TCI states comprise a second TCI state associated with the first CSI-RS. In certain aspects, the apparatus includes means for outputting, for transmission to the second wireless node, the first CSI-RS via a beam associated with the second TCI state.

Certain aspects are directed to an apparatus for wireless communications. In some examples, the apparatus includes means for outputting, for transmission to a user equipment (UE), a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the apparatus includes means for outputting, for transmission to the UE, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to a non-transitory computer-readable medium comprising instructions that, when executed by an apparatus, cause the apparatus to perform a method. In certain aspects, the method includes obtaining, from a second wireless node, a first channel state information reference signal (CSI-RS) associated with a first transmission configuration indicator (TCI) state. In certain aspects, the method includes obtaining, from the second wireless node, an indication of one or more TCI states associated with the first CSI-RS to be obtained, wherein the one or more TCI states comprise a second TCI state. In certain aspects, the method includes performing a beam adjustment based on the second TCI state to determine a beam. In certain aspects, the method includes obtaining the first CSI-RS via the beam.

Certain aspects are directed to a non-transitory computer-readable medium comprising instructions that, when executed by an apparatus, cause the apparatus to perform a method. In certain aspects, the method includes obtaining, from a network node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the method includes obtaining, from the network node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Certain aspects are directed to a non-transitory computer-readable medium comprising instructions that, when executed by an apparatus, cause the apparatus to perform a method. In certain aspects, the method includes outputting, for transmission to a second wireless node, a first channel state information reference signal (CSI-RS) associated with a first transmission configuration indicator (TCI) state. In certain aspects, the method includes outputting, for transmission to the second wireless node, an indication of one or more TCI states associated with the first CSI-RS to be obtained, wherein the one or more TCI states comprise a second TCI state associated with the first CSI-RS. In certain aspects, the method includes outputting, for transmission to the second wireless node, the first CSI-RS via a beam associated with the second TCI state.

Certain aspects are directed to a non-transitory computer-readable medium comprising instructions that, when executed by an apparatus, cause the apparatus to perform a method. In some examples, the method includes outputting, for transmission to a user equipment (UE), a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. In certain aspects, the method includes outputting, for transmission to the UE, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example monolithic (e.g., disaggregated) architecture of a distributed radio access network.

FIG. 5 is a block diagram illustrating an example disaggregated base station architecture.

FIG. 6 is a block diagram illustrating an example of MIMO beam forming.

FIG. 7 is a call flow diagram illustrating example communications between two wireless nodes.

FIG. 8 is a block diagram illustrating three examples of information carried in a medium access control-control element (MAC-CE).

FIG. 9 is a call flow diagram illustrating example communications between wireless nodes.

FIG. 10 is a block diagram illustrating an example MAC-CE.

FIG. 11 is a flow diagram illustrating an example method of communication between two wireless nodes.

FIG. 12 is a diagram illustrating an example of a hardware implementation for an example apparatus.

FIG. 13 is a flow diagram illustrating an example method of communication between two wireless nodes.

FIG. 14 is a diagram illustrating an example of a hardware implementation for an example apparatus.

FIG. 15 is a flow diagram illustrating an example method of communication between two wireless nodes.

FIG. 16 is a diagram illustrating an example of a hardware implementation for an example apparatus.

FIG. 17 is a flow diagram illustrating an example method of communication between two wireless nodes.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In certain aspects, cellular networks may provide a set of mechanisms by which user equipment (UE) and network nodes (e.g., gNBs) can establish directional transmission links, using high-dimensional phased arrays. The benefits of directional links include beamforming gain and a relatively high, sustainable communication quality. Directional links, however, require alignment of transmitter and receiver beams (e.g., beam pair), achieved through a set of operations known as beam management. Beam management operations may include initial access (IA) operations for idle users, which allows a UE to establish a physical link connection with a network node, and (ii) beam tracking, for connected users, which enable beam adaptation schemes, handover, path selection and radio link failure recovery procedures. For a beamformed transmission, the amplitude and phase of each antenna in an array of antennas may be precoded, or controlled to create a desired (e.g., directional) pattern of constructive and destructive interference in the wavefront.

Conventionally, beam management operations can run into problems. For example, a mobile wireless node may require frequent beam changing in order to maintain uninterrupted communication links due to the continually changing position and/or location of the wireless node. Moreover, the best beam pair may not necessarily correspond to transmitter and receiver beams that are physically pointing directly towards each other. Due to obstacles in the surrounding environment, such a “direct” path between the transmitter and receiver may be blocked and a reflected path may provide better connectivity. Thus, beam-management functionality must be able to handle such a situation and establish and retain a suitable beam pairing.

Typically, once an initial beam pair has been established, there is a need to regularly reevaluate the selection of transmitter-side and receiver-side beam directions due to movements and rotations of the wireless node. Furthermore, even for stationary devices, movements of other objects in the environment may block or unblock different beam pairs, implying a possible need to reevaluate the selected beam directions. To perform re-evaluation, the network node may transmit a set of reference signals corresponding to different downlink beams so that the wireless node can measure on the reference signals. The result of the measurements is then reported to the network which, based on the reporting, may decide to adjust the current beam.

In some examples, beam management techniques may include artificial intelligence (AI) and/or machine learning (ML) aspects. In such a case, one or more of the network node and the UE may measure signals transmitted from the other device and provide the other device with measurements of those signals (e.g., something indicative of those measurements). These measurements or observations may be used for training a ML model used to predict future TCI states for transmitted signals (e.g., reference signals). An indication of the predicted TCI states may be transmitted to the network node or to the UE, and the network node or UE may perform beam measurements on beams associated with the predicted TCI states to determine a preferred a preferred beam associated with the TCI state prior to switching TCI states. In other words, by obtaining predicted TCI states, a wireless node may perform beam measurements while concurrently communicating over beams associated with current TCI states. By performing the measurements prior to switching TCI states or being commanded to switch, the wireless node is better prepared to switch to a new TCI state upon receiving the command to switch, thereby improving communications.

In certain aspects, the disclosure relates to methods and techniques for indicating predicted future TCI states to another wireless node via a medium access control-control element (MAC-CE). For example, the TCI states may correspond to a particular semi-persistent or persistent channel state information reference signal (CSI-RS). In one example, a network node may transmit a MAC-CE to a UE to indicate predicted future TCI states relating to one or more CSI-RS Resources that are part of an activated set of CSI-RS resources. Thus, one or more one or more predicted future TCI states may be indicated in a single MAC-CE transmission.

In certain aspects, a wireless node may transmit an indication of a TCI state prediction capability. For example, a UE may transmit an indication of the prediction capability to a network node, enabling the network node to transmit predicted future TCI states to the UE. In some examples, the network node may transmit a signaling to the UE configured to request an indication from the UE of whether the UE has the prediction capability. The capability may indicate that the UE can support receiving a MAC-CE that includes the predicted TCI states.

In some examples, the MAC-CE may also include an indication of one or more CSI-RS resources associated with the predicted one or more TCI state(s). In one example, the MAC-CE may indicate one or more CSI-RS resource set identifiers (e.g., already activated CSI-RS resource sets). It should be noted that a CSI-RS resource set includes one or more CSI-RS resource identifiers associated with the CSI-RS resource set. That is, the set may include multiple CSI-RS resources. To reduce indication overhead, the CSI-RS resource identifiers may be identifiers defined within the CSI-RS resource set as opposed to identifiers as defined by the serving cell or network node. The MAC-CE may include one or more predicted future TCI-state(s) associated with the indicated CSI-RS resource.

In some examples, the MAC-CE may include the CSI-RS resource set identifier, but not include and CSI-RS resource identifiers associated with the set. Such an example may be used if the predicted TCI states correspond to all of the resources within the set. This may reduce the communication overhead associated with CSI-RS resource identifiers. In some examples, the MAC-CE may include a field indicating a format of the MAC-CE. For example, a first format of the MAC-CE may correspond to a MAC-CE format that includes the CSI-RS resource identifiers, while a second format may correspond to one that does not include the CSI-RS resource identifiers. In another example, different MAC-CE formats may be used without a field indicating the format.

In certain aspects, the MAC-CE carrying the predicted TCI state(s) may also include a predicted time instance or time window indicative of an estimated time when the wireless node should apply one or more predicted TCI states to their respective CSI-RS resources (e.g., the CSI-RS resources identified in the MAC-CE).

For example, the MAC-CE may include one or more predicted TCI states, with each predicted TCI state being associated with a particular CSI-RS resource. The future time instance or time window may also be included in the MAC-CE such that one or more predicted TCI states have a corresponding future time instance or time window. Here, the future time instance or time window is configured to indicate a prediction of when the corresponding TCI state is estimated to be updated. For example, a time instance may provide a specific instance of time in the future that a TCI state update is expected to occur. A time instance may indicate a high degree of accuracy in the estimation. In another example, a time window may provide a range of times within a window that a TCI state update is estimated to occur. A narrow time window may indicate a high degree of accuracy in the estimation relative to a wide time window. Thus, the time window or the time instance may provide an estimation of a time that a particular CSI-RS is to be updated.

In some examples, the time window may be indicated by a MAC-CE via a predicted mean value t1 (e.g., corresponding to a future time instance) and a standard deviation value Δt associated with the predicted mean value. In such an example, a wireless node receiving the MAC-CE can determine the time window as [t1−Δt, t1+Δt].

In some examples, the time window or time instance may be a predefined value (e.g., as provided by a wireless communication standard, and/or a value predefined by a network node). For example, the network node may indicate a time window or time instance via RRC messaging. In one such example, the RRC messaging may include a plurality of time windows and/or time instances, wherein each is mapped to another value. In this example, the network node or UE transmitting the MAC-CE may include one or more values mapped to a CSI-RS resource so that the node receiving the MAC-CE can perform a look-up to determine the corresponding time window or time instance.

In certain aspects, a wireless node such as a UE, receiving the MAC-CE may utilize the time instance or time window to modify or configure receive-beam refinement operations. For example, the UE may use the time window to perform the beam refinement operations, and may limit the operations (e.g., reduce a number of beams used and/or use wider beams) if the time window is narrow, or enhance the operations (e.g., include more beams and/or use narrower beams) if the time window is relatively wider. It should be noted that the UE may configure the beam refinement operations in order to complete the operations prior to expiration of the time window or prior to the time instance.

In certain aspects, the MAC-CE carrying the predicted TCI state(s) may also include an indication of an uncertainty level associated with one or more of the predicted TCI states. In one example, the uncertainty level may be explicitly indicated as a probability associated with one or more predicted TCI states. The uncertainty levels may be configured based on a pre-defined wireless standard, a configuration determined and provided by a network node, or a configuration determined and provided in a UE capability report.

In certain aspects, a wireless node may determine a receive-beam refinement operation according to an uncertainty level associated with a predicted TCI state. For example, a network node may configure the wireless node with a mapping between beam refinement operations and uncertainty levels. For example, each uncertainty level may correspond to a particular beam refinement operation. In some examples, the mapping between beam refinement operations and uncertainty levels may be configured via a wireless standard, a configuration determine and provided by a network node, and/or based on a recommendation and/or capability report provided by a UE.

In a first example, a network node may determine an uncertainty level associated with a TCI state that it predicted. The uncertainty level may control which transmit-beams the wireless node should focus on when performing the receive-beam refinement operation. For example, the MAC-CE may include a predicted TCI state associated with an SSB beam (e.g., SSB3) and an uncertainty level (e.g., “L”), where the value of L corresponds to a range of transmit beams or an amount of transmit beams that the wireless node should focus on when performing the receive-beam refinement operation. In one example, if L is greater than 20% and less than 50%, then the wireless node may include SSB3 as well as additional transmit beams associated with other SSBs (e.g., transmit beams associated with SSB1-SSB5) that neighbor SSB3 in the beam refinement operation. If L is less than 20% and greater than 5%, then the wireless node may include SSB3 as well as additional transmit beams, but only additional transmit beams that are directly adjacent to SSB3 (e.g., transmit beams associated with SSB2 and SSB4). If L is less than 5%, then the wireless node may focus solely on SSB3). In other words, if L is less than 5%, then the uncertainty level is relatively low (e.g., compared to L=50%), and thus, the receive-beam refinement operation does not require the wireless node to measure on a broad spectrum of different beams because the predicted TCI state is known with a relatively high certainty. It should be noted that the uncertainty levels discussed above are examples, and any suitable values and ranges may be used. In some examples, L may be provided in the MAC-CE as an integer or in any other suitable format.

In a second example, the network node may determine shapes (e.g., beam direction and/or beam width) of one or more transmit beams associated with its SSBs, and include both the shape information and the uncertainty level in the MAC-CE it transmits to a wireless node. For example, if the predicted TCI state included in the MAC-CE corresponds to a beam associated with SSB3, and the L value provided in the MAC-CE indicates a relatively high uncertainty level (e.g., 20%<L<50%), then the wireless node may expand the number of transmit beams it measures on when performing the receive-beam refinement operation to up to four additional beams (e.g., transmit beams associated with SSB1-SSB5), where SSB1, SSB2, SSB4, and SSB5 are the four spatially closest beams to SSB3, according to the shape information. If the predicted TCI state included in the MAC-CE corresponds to a beam associated with SSB3, and the L value provided in the MAC-CE indicates a relatively moderate uncertainty level (e.g., 5%<L<20%), then the wireless node may expand the number of transmit beams it measures on when performing the receive-beam refinement operation to up to two additional beams (e.g., transmit beams associated with SSB2-SSB4), where SSB2 and SSB4 are the two spatially closest beams to SSB3, according to the shape information. If the predicted TCI state included in the MAC-CE corresponds to a beam associated with SSB3, and the L value provided in the MAC-CE indicates a relatively low uncertainty level (e.g., L<5%), then the wireless node may not expand the number of transmit beams it measures on when performing the receive-beam refinement operation. Instead, the beam refinement operation may focus on the beam associated with SSB3, according to the shape information.

In a third example, the wireless node may use AI or ML to predict receive beams to be used by the wireless node based on the received predicted TCI state. In some examples, the wireless node may have a capability for using multiple AI/ML models to predict the receive beams. In some examples, the network node may provide, in a MAC-CE: a predicted TCI-state, an uncertainty level, and an indication of a particular AI or ML model to be used by the wireless node to predict the receive beams. For example, the AI/ML model may use the uncertainty level as an input to determine the predicted receive beams. In some examples, the indication of the particular AI or ML may be an integer identifying a model number associated with an AI/ML model. It should be noted that in some examples, the MAC-CE may not include the uncertainty level but rather just the model indication. Thus, the model indication may correspond to a particular uncertainty level. Accordingly, information mapping models to uncertainty levels may be configured at the wireless node via the network node, or may be configured according to a wireless standard.

In certain aspects, a wireless node such as a UE, may determine predicted TCI states and report the future predicted TCI states to the network node via an uplink MAC-CE. That is, the wireless node may also use a MAC-CE to report beam predictions made by the wireless node. The TCI states may be predicted using the same methods and techniques as described above, and may be communicated to the network node using the same MAC-CE methods and formats described above in reference to the network node. In addition, the receive-beam refinement operation described above may be performed by the UE after an uplink MAC-CE is received by the network node. In some examples, in response to the uplink MAC-CE, the network node may transmit additional information (e.g., confirmation or alternation) of the receive-beam refinement operation to the wireless node. The wireless node may then modify the receive-beam refinement operation if necessary.

In certain aspects, a total number of active CSI-RS resources should not exceed a reported capability of a wireless node. That is, to update TCI states for a semi-persistent (SP-CSI-RS) resource set, the network node may need to first deactivate a CSI-RS resource set via a SP-CSI-RS deactivation MAC-CE, and then re-activate it using an SP-CSI-RS activation MAC-CE which carries updated TCI states. Currently, there is no definition of future TCI states regarding SP-CSI-RS resources, and the wireless node has to assume that the updated TCI states in the activation MAC-CE will take immediate effect.

This may result in several problems. First, there may be no time for the wireless node to refine its receive beams before actually receiving the SP-CSI-RS resources over beams associated with the updated TCI states. And second, if beam change happens frequently, such deactivation/reactivation may cause to unnecessarily wasted overhead.

Thus, in certain aspects, a TCI state may be reactivated by a MAC-CE (e.g., any of the aforementioned MAC-CE formats and configurations) without first transmitting a deactivation MAC-CE. For example, a first CSI-RS resource may be active at a wireless node, wherein the first CSI-RS resource is associated with a first TCI state. Then, without receiving a deactivation MAC-CE, the wireless node may receive, from the network node, another MAC-CE indicating the same first CSI-RS resource and associating it with a second TCI state. The wireless node may then replace the first TCI state with the second TCI state so that the first CSI-RS resource is associated with the second TCI state without having to first deactivate then reactivate the first CSI-RS resource. Because the MAC-CE used to activate the second TCI state can be any of the aforementioned MAC-CE formats and configurations discussed above, the MAC-CE may indicate a CSI-RS resource identifier or a CSI-RS resource set comprising one or more CSI-RS resource identifiers.

In some examples, the MAC-CE may not include a time instance or a time window associated with the updated TCI-state. For instance, the time instance may be the next applicable occasion associated with the CSI-RS resource (e.g., a slot that immediately follows the slot carrying the MAC-CE). In some examples, the MAC-CE may not include an uncertainty level associated with the updated TCI state. For instance, the uncertainty level may be considered to be 0% (e.g., 100% certain).

In some examples, the wireless node may report, to the network node, a capability supporting communication of a MAC-CE for reactivating a TCI state. In some examples, the network node may configure the wireless node with the capability supporting communication of a MAC-CE for reactivating a TCI state. For example, the network node may transmit information to the wireless node.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

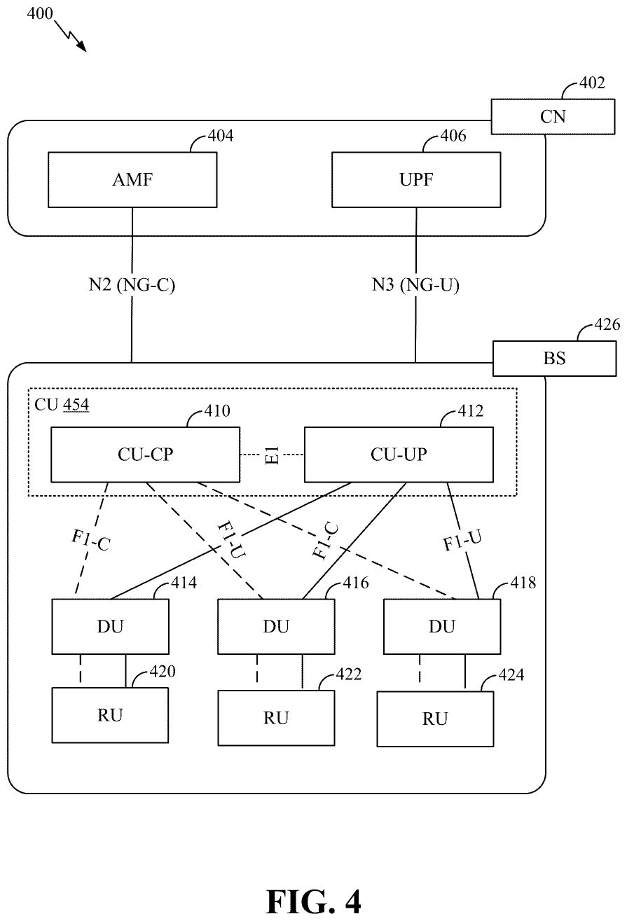

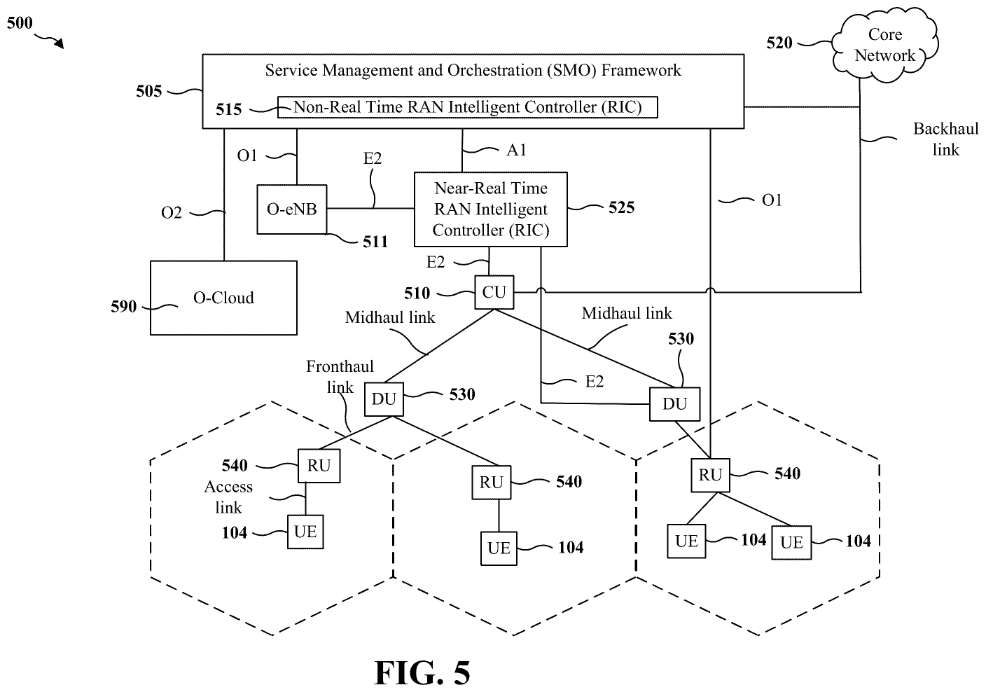

Throughout the disclosure, a “network node” may be used to refer to a base station, or a disaggregated component of a base station. For example, a base station may be implemented as an aggregated base station (e.g., as described in reference to FIG. 4) or as a disaggregated base station (e.g., as described in reference to FIG. 5). Thus, in some examples, a network node may refer to one or more of a central unit (CU), a distributed unit (DU), a radio unit (RU), a near-real time (near-RT) radio access network (RAN) intelligent controller (RIC), and/or a non-real time (non-RT) RIC. In some examples, the network node may be an integrated access and backhaul (IAB) node, a relay node, etc.

Throughout the disclosure, a “wireless node” may be used to refer to a network node or a user equipment (UE).

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

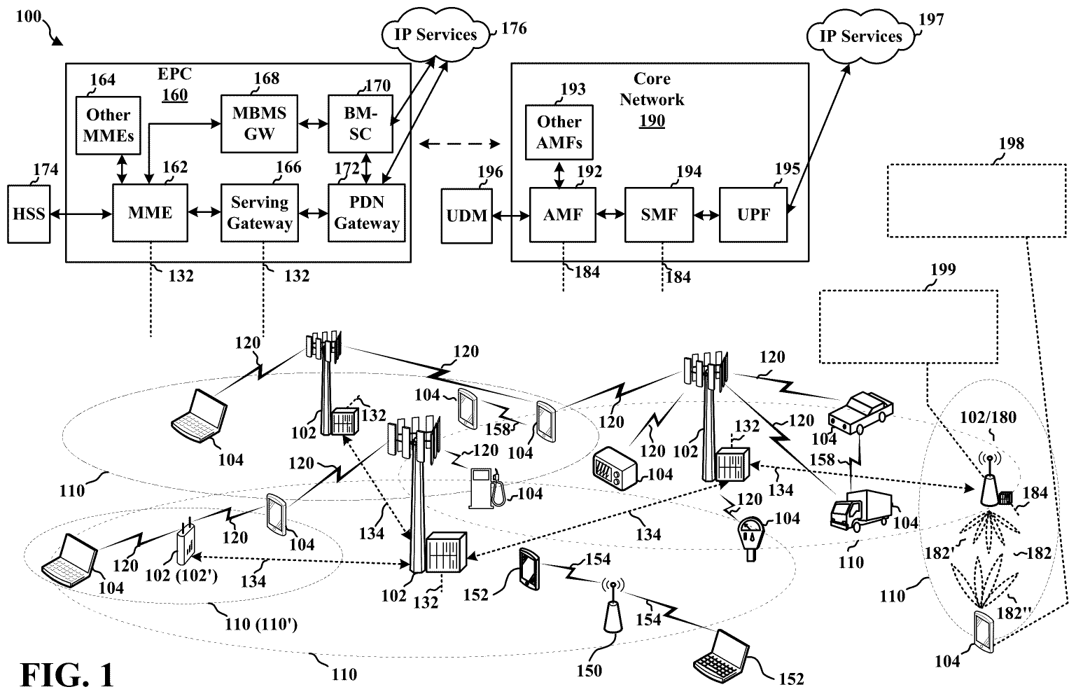

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MH2) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured with a TCI state management module 198. The TCI state management module 198 may be configured to obtain, from a wireless node, a first channel state information reference signal (CSI-RS) associated with a first transmission configuration indicator (TCI) state; obtain, from the wireless node, an indication of one or more TCI states associated with the first CSI-RS to be obtained, wherein the one or more TCI states comprise a second TCI state; perform a beam adjustment based on the second TCI state to determine a beam; and obtain the first CSI-RS via the beam.

In certain aspects, the TCI state management module 198 may also be configured to obtain, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and obtain, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

In certain aspects, the TCI state management module 198 may also be configured to output, for transmission to a wireless node, a first channel state information reference signal (CSI-RS) associated with a first transmission configuration indicator (TCI) state; output, for transmission to the wireless node, an indication of one or more TCI states associated with the first CSI-RS to be obtained, wherein the one or more TCI states comprise a second TCI state associated with the first CSI-RS; and output, for transmission to the wireless node, the first CSI-RS via a beam associated with the second TCI state.

Referring again to FIG. 1, in certain aspects, the base station 180 may be configured with a TCI state management module 199 configured to obtain, from a wireless node, a first channel state information reference signal (CSI-RS) associated with a first transmission configuration indicator (TCI) state; obtain, from the wireless node, an indication of one or more TCI states associated with the first CSI-RS to be obtained, wherein the one or more TCI states comprise a second TCI state; perform a beam adjustment based on the second TCI state to determine a beam; and obtain the first CSI-RS via the beam.

In certain aspects, the TCI state management module 199 may also be configured to output, for transmission to a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and output, for transmission to the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

In certain aspects, the TCI state management module 199 may also be configured to output, for transmission to a wireless node, a first channel state information reference signal (CSI-RS) associated with a first transmission configuration indicator (TCI) state; output, for transmission to the wireless node, an indication of one or more TCI states associated with the first CSI-RS to be obtained, wherein the one or more TCI states comprise a second TCI state associated with the first CSI-RS; and output, for transmission to the wireless node, the first CSI-RS via a beam associated with the second TCI state.

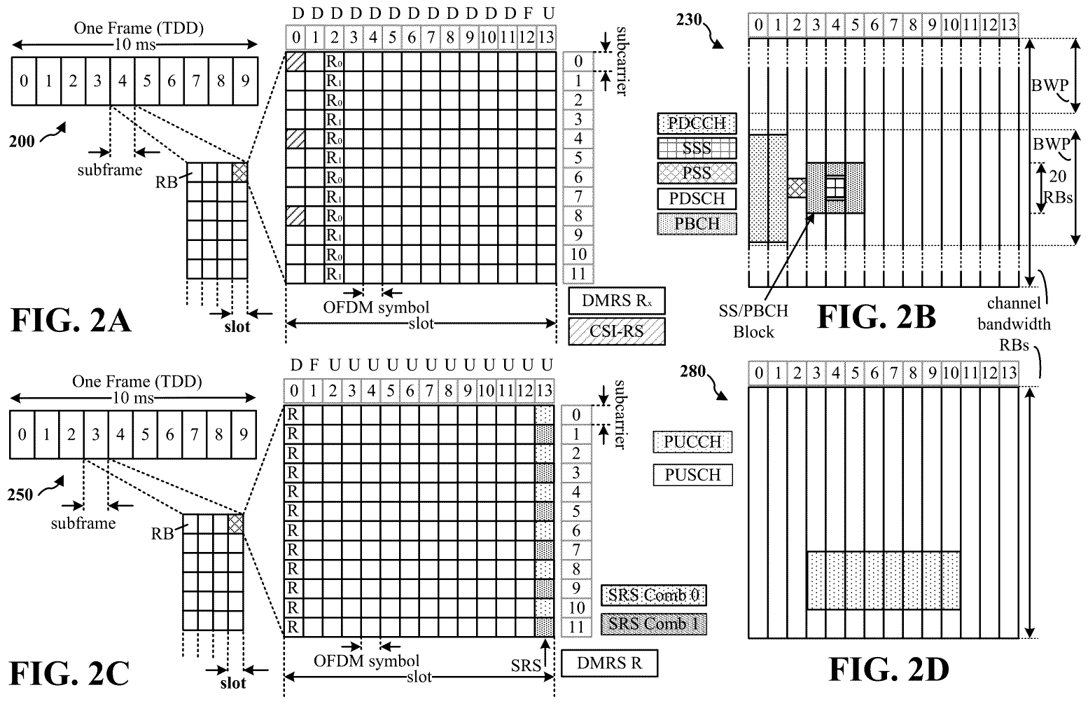

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 24*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

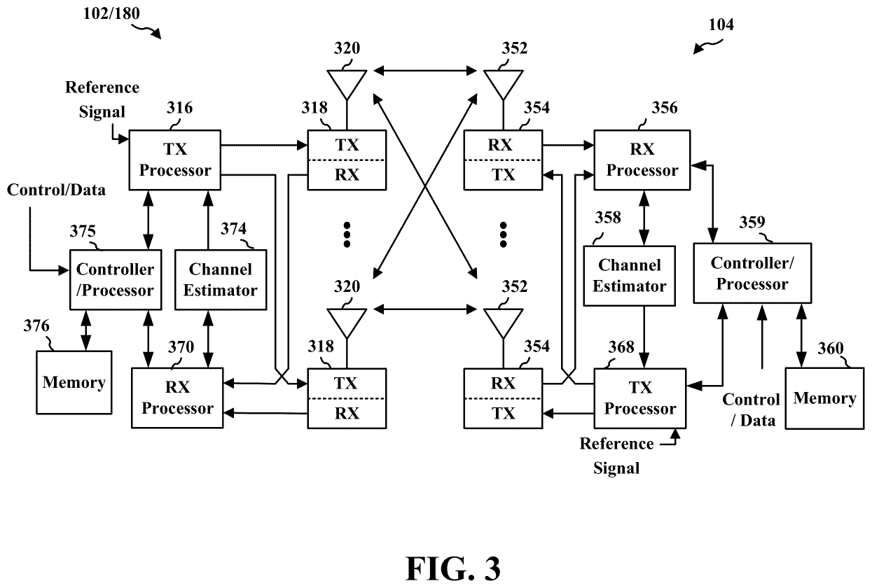

FIG. 3 is a block diagram of a base station 102 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

FIG. 4 illustrates an example monolithic (e.g., disaggregated) architecture of a distributed RAN 400, which may be implemented in the wireless communications system and an access network 100 illustrated in FIG. 1. As illustrated, the distributed RAN 400 includes core network (CN) 402 and a base station 426.

The CN 402 may host core network functions. CN 402 may be centrally deployed. CN 402 functionality may be offloaded (e.g., to advanced wireless services (AWS)), in an effort to handle peak capacity. The CN 402 may include an AMF 404 and a UPF 406. The AMF 404 and UPF 406 may perform one or more of the core network functions.

The base station 426 may communicate with the CN 402 (e.g., via a backhaul interface). The base station 426 may communicate with the AMF 404 via an N2 (e.g., NG-C) interface. The base station 426 may communicate with the UPF 406 via an N3 (e.g., NG-U) interface. The base station 426 may include a central unit-control plane (CU-CP) 410, one or more central unit-user planes (CU-UPs) 412, one or more distributed units (DUs) 414-418, and one or more radio units (RUS) 420-424.

The CU-CP 410 may be connected to one or more of the DUs 414-418. The CU-CP 410 and DUs 414-418 may be connected via a F1-C interface. As shown in FIG. 4, the CU-CP 410 may be connected to multiple DUs, but the DUs may be connected to only one CU-CP. Although FIG. 4 only illustrates one CU-UP 412, the base station 426 may include multiple CU-UPs. The CU-CP 410 selects the appropriate CU-UP(s) for requested services (e.g., for a UE). The CU-UP(s) 412 may be connected to the CU-CP 410. For example, the CU-UP(s) 412 and the CU-CP 410 may be connected via an E1 interface. The CU-UP(s) 412 may be connected to one or more of the DUs 414-418. The CU-UP(s) 412 and DUs 414-418 may be connected via a F1-U interface. As shown in FIG. 4, the CU-CP 410 may be connected to multiple CU-UPS, but the CU-UPs may be connected to only one CU-CP 410.

A DU, such as DUs 414, 416, and/or 418, may host one or more TRP(s) (transmit/receive points, which may include an edge node (EN), an edge unit (EU), a radio head (RH), a smart radio head (SRH), or the like). A DU may be located at edges of the network with radio frequency (RF) functionality. A DU may be connected to multiple CU-UPs that are connected to (e.g., under the control of) the same CU-CP (e.g., for RAN sharing, radio as a service (RaaS), and service specific deployments). DUs may be configured to individually (e.g., dynamic selection) or jointly (e.g., joint transmission) serve traffic to a UE. Each DU 414-416 may be connected with one of RUs 420/422/424.

The CU-CP 410 may be connected to multiple DU(s) that are connected to (e.g., under control of) the same CU-UP 412. Connectivity between a CU-UP 412 and a DU may be established by the CU-CP 410. For example, the connectivity between the CU-UP 412 and a DU may be established using bearer context management functions. Data forwarding between CU-UP(s) 412 may be via a Xn-U interface.

The distributed RAN 400 may support fronthauling solutions across different deployment types. For example, the RAN 400 architecture may be based on transmit network capabilities (e.g., bandwidth, latency, and/or jitter). The distributed RAN 400 may share features and/or components with LTE. For example, the base station 426 may support dual connectivity with NR and may share a common fronthaul for LTE and NR. The distributed RAN 400 may enable cooperation between and among DUs 414-418, for example, via the CU-CP 412. An inter-DU interface may not be used. Logical functions may be dynamically distributed in the distributed RAN 400.

FIG. 5 is a block diagram illustrating an example disaggregated base station 500 architecture. The disaggregated base station 500 architecture may include one or more CUs 510 that can communicate directly with a core network 520 via a backhaul link, or indirectly with the core network 520 through one or more disaggregated base station units (such as a near real-time (RT) RIC 525 via an E2 link, or a non-RT RIC 515 associated with a service management and orchestration (SMO) Framework 505, or both). A CU 510 may communicate with one or more DUs 530 via respective midhaul links, such as an F1 interface. The DUs 530 may communicate with one or more RUs 540 via respective fronthaul links. The RUs 540 may communicate with respective UEs 104 via one or more radio frequency (RF) access links. In some implementations, the UE 104 may be simultaneously served by multiple RUs 540.

Each of the units, i.e., the CUs 510, the DUs 530, the RUs 540, as well as the near-RT RICs 525, the non-RT RICs 515 and the SMO framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., central unit-user plane (CU-UP)), control plane functionality (i.e., central unit-control plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the DU 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 104. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a virtual RAN (vRAN) architecture.

The SMO Framework 505 may be configured to support RAN deployment and provisioning of non-virtualized and virtualized network elements. For non-virtualized network elements, the SMO framework 505 may be configured to support the deployment of dedicated physical resources for RAN coverage requirements, which may be managed via an operations and maintenance interface (such as an O1 interface). For virtualized network elements, the SMO framework 505 may be configured to interact with a cloud computing platform (such as an open cloud (O-cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and near-RT RICs 525. In some implementations, the SMO framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO framework 505 also may include the non-RT RIC 515 configured to support functionality of the SMO Framework 505. The non-RT RIC 515 may be configured to include a logical function that enables non-real-time control and optimization of RAN elements and resources, artificial intelligence/machine learning (AI/ML) workflows including model training and updates, or policy-based guidance of applications/features in the near-RT RIC 525. The non-RT RIC 515 may be coupled to or communicate with (such as via an A1 interface) the near-RT RIC 525. The near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the near-RT RIC 525.

In some implementations, to generate AI/ML models to be deployed in the near-RT RIC 525, the non-RT RIC 515 may receive parameters or external enrichment information from external servers. Such information may be utilized by the near-RT RIC 525 and may be received at the SMO Framework 505 or the non-RT RIC 515 from non-network data sources or from network functions. In some examples, the non-RT RIC 515 or the near-RT RIC 525 may be configured to tune RAN behavior or performance. For example, the non-RT RIC 515 may monitor long-term trends and patterns for performance and employ AI/ML models to perform corrective actions through the SMO Framework 505 (such as reconfiguration via 01) or via creation of RAN management policies (such as A1 policies).

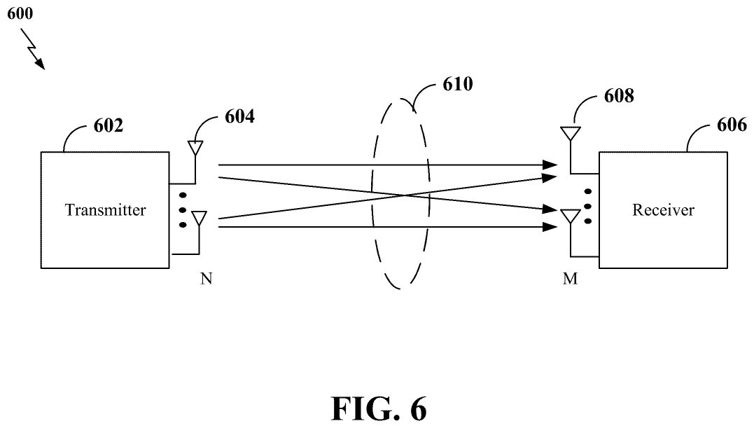

In some aspects of the disclosure, a wireless node may be configured for beamforming and/or multiple-input multiple-output (MIMO) technology. FIG. 6 illustrates an example of a wireless communication system 600 supporting MIMO. In a MIMO system, a transmitter 602 includes multiple transmit antennas 604 (e.g., N transmit antennas) and a receiver 606 includes multiple receive antennas 608 (e.g., M receive antennas). Thus, there are N×M signal paths 610 from the transmit antennas 604 to the receive antennas 608. Each of the transmitter 602 and the receiver 606 may be implemented, for example, within a network node 102, a UE 104, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

Beamforming may relate to directional signal transmission or reception. For a beamformed transmission, the amplitude and phase of each antenna in an array of antennas may be precoded, or controlled to create a desired (e.g., directional) pattern of constructive and destructive interference in the wavefront. The number of data streams or layers corresponds to the rank of the transmission. In general, the rank of the MIMO system 600 is limited by the number of transmit or receive antennas 604 or 608, whichever is lower.

In the simplest case, as shown in FIG. 6, a rank-2 spatial multiplexing transmission on a 2×2 MIMO antenna configuration will transmit one data stream from each transmit antenna 604. Each data stream reaches each receive antenna 608 along a different signal path 610. The receiver 606 may then reconstruct the data streams using the received signals from each receive antenna 608.

### Example Methods and Techniques for Transmission Configuration Indicator (TCI) State Communications

In certain aspects, beam management techniques may include artificial intelligence (AI) and/or machine learning (ML) features. In such a case, one or more of a network node and a UE may measure signals transmitted from the other device and provide the other device with measurements of those signals (e.g., something indicative of those measurements). The measurements may be used to train an AI/ML model configured to predict future TCI states for transmitted signals (e.g., reference signals). An indication of the predicted TCI states may be transmitted to the network node or to the UE, and the network node or UE may perform beam measurements on beams associated with the predicted TCI states to determine a preferred a preferred beam associated with the TCI state prior to switching TCI states. In other words, by obtaining predicted TCI states, a wireless node may perform beam measurements while concurrently communicating over beams associated with current TCI states. By performing the measurements prior to switching TCI states or being commanded to make such a switch, the wireless node is better prepared to switch to a new TCI state upon receiving the command to switch, thereby improving communications.

In certain aspects, a wireless node (e.g., network node or UE) may predict a future TCI state and transmit an indication of the predicted TCI state to another wireless node. In some examples, the indication of the predicted TCI state may be transmitted via a medium access control-control element (MAC-CE) or any other suitable structure for transmitting information wirelessly. The TCI states may be associated with a particular semi-persistent or persistent reference signal. In some examples, the reference signal may include a channel state information reference signal (CSI-RS).

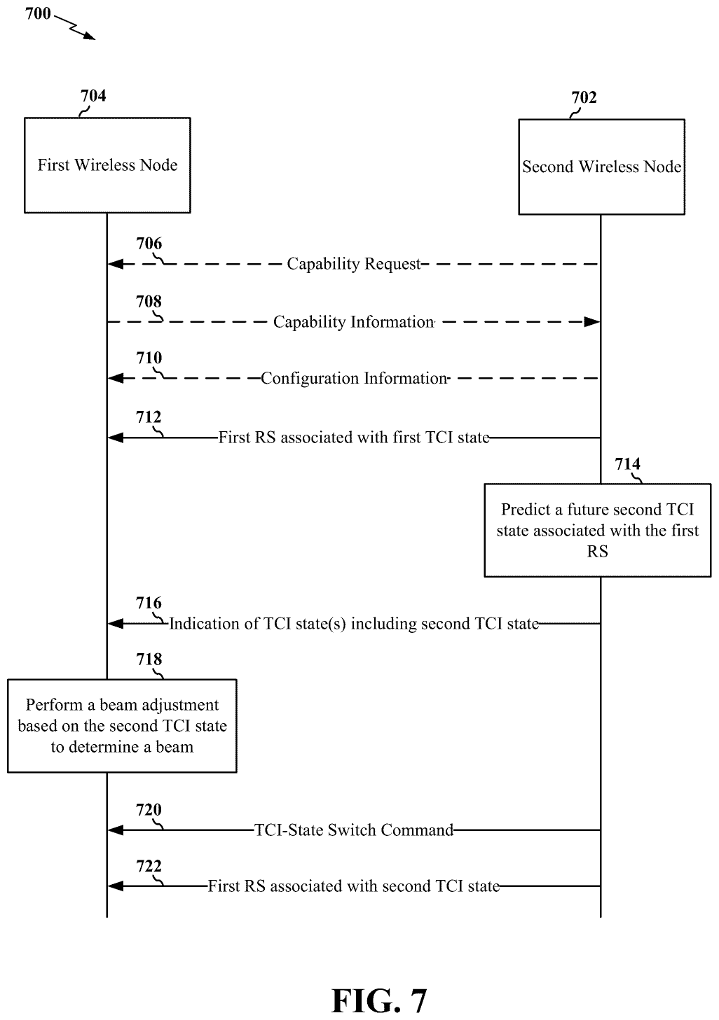

FIG. 7 is a call-flow diagram 700 illustrating example communications between a first wireless node 704 (e.g., a network node 102 or a UE 104 of FIGS. 1 and 3) and a second wireless node 702 (e.g., a UE 104 or a network node 102 of FIGS. 1 and 3).

Initially, the second wireless node 702 may transmit a capability request to the first wireless node 704 in an optional first communication 706. Here, the second wireless node 702 may request information about whether the first wireless node 704 is capable of receiving an indication of one or more predicted future TCI states and/or performing receive-beam refinement operations using the future TCI states in response to the indication.

In an optional second communication 708, the first wireless node 704 may respond to the capability request with information configured to notify the second wireless node 702 of its capability for receiving the indication of one or more predicted future TCI states and/or performing receive-beam refinement operations using the future TCI states in response to the indication. In some examples, the first wireless node 704 may voluntarily transmit the second communication 708 (e.g., transmitted independent of whether first wireless node has received the first communication 706) during a link establishment or any other suitable time. In some examples, one or more of the first communication 706 and the second communication 708 may be transmitted via a radio resource control (RRC) message.

In a third communication 710, the second wireless node 702 may optionally transmit configuration information to the first wireless node 704. The configuration information may include an indication of one or more MAC-CE formats (e.g., information carried by the MAC-CE), information regarding receive-beam refinement operations to be performed by the first wireless node 704 (e.g., according to certainty/uncertainty levels, time windows and/or time instances, etc.), and AI/ML models to be used by the first wireless node 704. The first communication 706, second communication 708, and/or the third communication 710 may be performed via radio resource control (RRC) messaging.

At a fourth communication 712, the second wireless node 702 may transmit a first reference signal (RS) associated with a first transmission configuration indicator (TCI) state. The first reference signal may be transmitted via a first transmit beam. In some examples, the first reference signal may be a channel state indication RS (CSI-RS) signal having an associated TCI state as provided in a semi-periodic (SP) CSI-RS resource set activation/deactivation MAC-CE (e.g., first MAC-CE) described in 3GPP 38.321. The SP CSI-RS resource set activation/deactivation MAC-CE may include an indication of one or more CSI-RS resource set identifiers and at least one TCI state associated with each of the one or more CSI-RS resource sets. The first wireless node 704 may receive the first CSI-RS associated with first TCI state.

In some examples, one or more of the first wireless node 704 and the second wireless node 702 may be mobile, or if neither are mobile, there may be environmental aspects that affect communication throughput (e.g., automobile traffic, construction, etc., causing beam reflections or other interference between the first wireless node 704 and the second wireless node 702). Accordingly, one or more of the first wireless node 704 and the second wireless node 702 may include an AI/ML model configured to predict a future TCI state of a CSI-RS resource based on previous signal measurements.

At a first process 714, the second wireless node 702 may use an AI/ML model to predict one or more future TCI states of the first CSI-RS. That is, the second wireless node 702 may predict a second TCI state of the first CSI-RS at a future time instance or within a future time window.

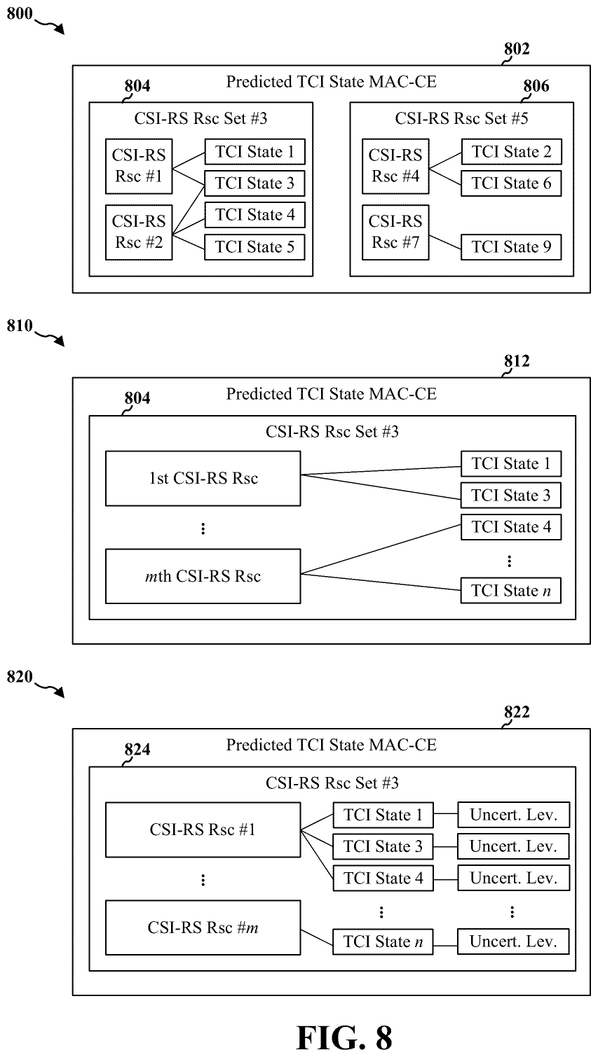

At a fifth communication 716, the second wireless node 704 may transmit to the first wireless node 704 an indication of one or more TCI states associated with the first RS at a future time, wherein the one or more TCI states comprise a second TCI state. That is, the one or more TCI states may be predicted TCI states of the first CSI-RS at a future time instance or time window. The indication of the one or more TCI states associated with the first RS may be transmitted via a second MAC-CE (e.g., as illustrated in the three examples of FIG. 8), wherein the second MAC-CE is a different format relative to the first MAC-CE.

The second MAC-CE may be configured to include an indication of one or more CSI-RS resources associated with one or more TCI state(s). In one example, the MAC-CE may indicate one or more CSI-RS resource set identifiers (e.g., already activated CSI-RS resource sets). It should be noted that a CSI-RS resource set includes one or more CSI-RS resources associated with the CSI-RS resource set. The MAC-CE may include one or more predicted future TCI-state(s) associated with the indicated CSI-RS resource.

Referring now to FIG. 8, three block diagrams are shown conceptually illustrating three example formats of the second MAC-CE for providing the first wireless node 704 with the indication of the one or more TCI states associated with the first RS. It should be noted that the information associated with each of the three examples may be included in another of the three examples. In other words, the three examples are not limited to the information illustrated. The second MAC-CE may include information configured to indicate at least one CSI-RS via one or more of a CSI-RS resource set identifier (ID), and/or a CSI-RS resource ID. Similarly, the second MAC-CE may include an indication of one or more predicted future TCI states associated with each indicated CSI-RS resource set ID and/or CSI-RS resource ID.

In a first example 800, the MAC-CE 802 includes an indication of two CSI-RS resource sets (e.g., CSI-RS resource set #3 804 and CSI-RS resource set #5 806). It should be noted that two CSI-RS resource sets are shown for exemplary purposes, and that the MAC-CE 802 may include any suitable number of CSI-RS resource sets, including one or more. Each of the two CSI-RS resources sets may indicated by any suitable identifier (e.g., NZP-CSI-RS-resource information element (IE)). CSI-RS resource set #3 804 includes four predicted future TCI states: TCI state 1, TCI state 3, TCI state 4, and TCI state 5. TCI state 1 and TCI state 3 may be mapped to CSI-RS resource #1, indicating the second wireless node 702 has predicted that TCI state 1 or TCI state 3 will be the future TCI state for CSI-RS resource #1 of CSI-RS resource set #3 804. TCI state 3, TCI state 4, and TCI state 5 may be mapped to CSI-RS resource #2, indicating the second wireless node 702 has predicted that TCI state 3, TCI state 4, or TCI state 5 will be the future TCI state for CSI-RS resource #2 of CSI-RS resource set #3 804. It should be noted that the number of TCI states associated with a CSI-RS resource may be indicative of an uncertainty level. For example, if a CSI-RS resource #2 has more TCI states associated with it than CSI-RS resource #1, which may indicate that the second wireless node 702 has less certainty in its prediction of a future TCI state for CSI-RS resource #2, relative to CSI-RS resource #1.

CSI-RS resource set #5 806 includes two CSI-RS resources (CSI-RS resource #4 and CSI-RS resource #7). CSI-RS resource set #5 806 includes three predicted future TCI states: TCI state 2, TCI state 6, and TCI state 9. TCI state 2 and TCI state 6 may be mapped to CSI-RS resource #4, indicating the second wireless node 702 has predicted that TCI state 2 or TCI state 6 will be the future TCI state for CSI-RS resource #4 of CSI-RS resource set #5 806. TCI state 9 may be mapped to CSI-RS resource #7, indicating the second wireless node 702 has predicted that TCI state 9 will be the future TCI state for CSI-RS resource #7 of CSI-RS resource set #5 806.

Thus, the first example 800 may include an indication of one or more CSI-RS resources associated with the predicted one or more TCI state(s). The MAC-CE may indicate one or more CSI-RS resource set identifiers (e.g., already activated CSI-RS resource sets). A CSI-RS resource set may include one or more CSI-RS resources associated with the CSI-RS resource set. To reduce indication overhead, the CSI-RS resources may be identified according to identifiers that are provided by a serving cell (e.g., second wireless node 702), or identifiers defined within the CSI-RS resource set. It should be noted that the CSI-RS resources indicated by the MAC-CE 802 may include all, or less than all of the CSI-RS resources associated with each CSI-RS resource set. For example, if there is no predicted TCI state change in a particular CSI-RS resource, it may not be indicated within the corresponding resource set.

In a second example 810, the MAC-CE 812 may include a CSI-RS resource set identifier (e.g., CSI-RS resource set #3 814), but not include CSI-RS resource identifiers associated with the resources within the set. Such an example may be used if the predicted TCI states correspond to all of the resources within the set. This may reduce the communication overhead associated with CSI-RS resource identifiers. In some examples, the MAC-CE may include a field indicating a format of the MAC-CE. For example, a first format of the MAC-CE may correspond to a MAC-CE format that includes the CSI-RS resource identifiers (e.g., MAC-CE 802 format), while a second format may correspond to one that does not include the CSI-RS resource identifiers (e.g., MAC-CE 812 format). In another example, different MAC-CE formats may be used without a field indicating the format. The example MAC-CE 812 is illustrated as including a single CSI-RS resource set (e.g., CSI-RS resource set #3 814), although the MAC-CE 812 may include additional sets.

In a third example 820, the MAC-CE 822 may include a certainty/uncertainty level associated with one or more of the predicted future TCI states indicated in the same MAC-CE. In one example, the uncertainty level may be explicitly indicated as a probability associated with one or more predicted TCI states. The uncertainty levels may be configured based on a pre-defined wireless standard, a configuration determined and provided by a network node (e.g., in the configuration information of the third communication 710 of FIG. 7), or a configuration determined and provided in a UE capability report (e.g., in the capability information of the second communication 708 of FIG. 7). The MAC-CE 822 may include an indication of one or more of a CSI-RS resource set 824 or a CSI-RS resource.

In certain aspects, the first wireless node 704 may determine parameters (e.g., duration, number of beams, etc.) for a receive-beam refinement operation (e.g., second process 718 of FIG. 7) according to an uncertainty level associated with a predicted TCI state. For example, the second wireless node 702 may configure the first wireless node 704 with a mapping between beam refinement operations and uncertainty levels in the third communication 710 of FIG. 7. For example, each uncertainty level may correspond to a particular beam refinement operation. In some examples, the mapping between beam refinement operations and uncertainty levels may be configured based on a wireless standard, and/or based on a recommendation and/or capability report (e.g., the capability information of the second communication 708 of FIG. 7) provided by the first wireless node 704.

The second wireless node 702 may determine an uncertainty level associated with a TCI state that it predicted. The uncertainty level may control which transmit-beams the first wireless node 704 should focus on when performing the receive-beam refinement operation. For example, the MAC-CE may include a predicted TCI state associated with an SSB beam (e.g., SSB3) and an uncertainty level (e.g., “L”), where the value of L corresponds to a range of transmit beams or an amount of transmit beams that the first wireless node 704 should focus on when performing the receive-beam refinement operation. In one example, if L is greater than 20% and less than 50%, then the first wireless node 704 may include SSB3 as well as additional transmit beams associated with other SSBs (e.g., transmit beams associated with SSB1-SSB5) that neighbor SSB3 in the beam refinement operation. If L is less than 20% and greater than 5%, then the first wireless node 704 may include SSB3 as well as additional transmit beams, but only additional transmit beams that are directly adjacent to SSB3 (e.g., transmit beams associated with SSB2 and SSB4). If L is less than 5%, then the first wireless node 704 may focus solely on SSB3). In other words, if L is less than 5%, then the uncertainty level is relatively low (e.g., compared to L=50%), and thus, the receive-beam refinement operation does not require the first wireless node 704 to measure on a broad spectrum of different beams because the predicted TCI state is known with a relatively high certainty. It should be noted that the uncertainty levels discussed above are examples, and any suitable values and ranges may be used. In some examples, L may be provided in the MAC-CE as an integer or in any other suitable format.

In a second example, the second wireless node 702 may determine shapes (e.g., beam direction and/or beam width) of one or more transmit beams associated with its SSBs and include both the shape information and the uncertainty level in the MAC-CE it transmits to the first wireless node 704 in the fifth communication 716. For example, if the predicted TCI state included in the MAC-CE corresponds to a beam associated with SSB3, and the L value provided in the MAC-CE indicates a relatively high uncertainty level (e.g., 20%<L<50%), then the first wireless node 704 may expand the number of transmit beams it measures on when performing the receive-beam refinement operation to up to four additional beams (e.g., transmit beams associated with SSB1-SSB5), where SSB1, SSB2, SSB4, and SSB5 are the four spatially closest beams to SSB3, according to the shape information. If the predicted TCI state included in the MAC-CE corresponds to a beam associated with SSB3, and the L value provided in the MAC-CE indicates a relatively moderate uncertainty level (e.g., 5%<L<20%), then the first wireless node 704 may expand the number of transmit beams it measures on when performing the receive-beam refinement operation to up to two additional beams (e.g., transmit beams associated with SSB2-SSB4), where SSB2 and SSB4 are the two spatially closest beams to SSB3, according to the shape information. If the predicted TCI state included in the MAC-CE corresponds to a beam associated with SSB3, and the L value provided in the MAC-CE indicates a relatively low uncertainty level (e.g., L<5%), then the first wireless node 704 may not expand the number of transmit beams it measures on when performing the receive-beam refinement operation. Instead, the beam refinement operation may focus on the beam associated with SSB3, according to the shape information.

In a third example, the first wireless node 704 may use AI or ML to predict receive beams to be used by the first wireless node 704 based on the received predicted TCI state. In some examples, the first wireless node 704 may have a capability for using multiple AI/ML models to predict the receive beams. The first wireless node 704 may provide the second wireless node 702 with an indication of the AI/ML model(s) it is capable of using in the capability information of the second communication 708. Thus, in the MAC-CE of the fifth communication 716, the second wireless node 702 may provide: a predicted TCI-state, an uncertainty level associated with the predicted TCI state, and an indication of a particular AI or ML model to be used by the wireless node to predict the receive beams associated with the predicted TCI state. In some examples, the AI/ML model may use the uncertainty level as an input to determine the predicted receive beams. In some examples, the indication of the particular AI/ML may be an integer identifying a model number associated with an AI/ML model. It should be noted that in some examples, the MAC-CE may not include the uncertainty level but rather just the model indication. Thus, the model indication may correspond to a particular uncertainty level. Accordingly, information mapping models to uncertainty levels may be configured at the first wireless node 704 via the second wireless node 702 in the configuration information of the third communication 710, or may be configured according to a wireless standard.

As discussed, the second wireless node 702 may also be configured to estimate a predicted time instance or time window indicative of an estimated time when the first wireless node 704 should apply one or more predicted TCI states to their respective CSI-RS resources (e.g., the CSI-RS resources identified in the MAC-CE). For example, the second wireless node 702 may predict such a time during the first process 714. Thus, the MAC-CE transmitted in the fifth communication may carry the predicted TCI state(s) as well as predicted time instance or time window associated with one or more of the predicted TCI states.

For example, each predicted TCI state may be associated with a particular CSI-RS resource. The future time instance or time window may also be included in the MAC-CE such that one or more predicted TCI states have a corresponding future time instance or time window. Here, the future time instance or time window is configured to indicate a prediction of when the corresponding TCI state is estimated to be updated. For example, a time instance may provide a specific instance of time in the future that a TCI state update (e.g., a TCI state switch command transmitted in a sixth communication 720) is expected to occur. A time instance may indicate a high degree of accuracy in the estimation relative to a time window. A time window may provide a range of times within a window that a TCI state update is estimated to occur. A narrow time window may indicate a high degree of accuracy in the estimation relative to a wide time window. Thus, the time window or the time instance may provide an estimation of a time that a TCI state of a particular CSI-RS is to be updated.

In some examples, the time window may be indicated by a MAC-CE via a predicted mean value t1 (e.g., corresponding to a future time instance) and a standard deviation Δt associated with the predicted mean value. In such an example, the first wireless node 704 receiving the MAC-CE can determine the time window as [t1−Δt, t1+Δt].

In some examples, the time window or time instance may be a predefined value (e.g., as provided by a wireless communication standard, and/or a value predefined by the second wireless node 702 and provided to the first wireless node 704 (e.g., in the configuration information of the third communication 710). In one such example, the second wireless node 702 may provide a plurality of time windows and/or time instances, wherein each is mapped to another value such as an integer. Thus, the one or more of the CSI-RS resources or the predicted TCI states of the MAC-CE transmitted by the second wireless node 702 may be mapped to one or more integer values indicating a time window or time instance. Here, the first wireless node 704 may use the mapping to determine a time window or time instance corresponding to a particular TCI state.

The first wireless node 704 may utilize the time instance or time window to modify or configure receive-beam refinement operations of the second process 718. For example, the first wireless node 704 may use the time window to perform the beam refinement operations, and may limit the operations (e.g., reduce a number of beams used and/or use wider beams) if the time window is narrow, or enhance the operations (e.g., include more beams and/or use narrower beams) if the time window is relatively wider. It should be noted that the first wireless node 704 may configure the beam refinement operations in order to complete the operations prior to expiration of the time window or prior to the time instance.

Referring back to FIG. 7, at a second process 718, the first wireless node 704 may use the predicted second TCI state to perform a receive beam adjustment operation based on the second TCI state. For example, the second TCI state may correspond to a particular SSB beam, and the first wireless node 704 may perform a beam refinement procedure to determine a receive beam to use for receiving the first CSI-RS when the first CSI-RS is disassociated with the first TCI state and associated with the second TCI state.

At a sixth communication 720, the second wireless node 702 may transmit a TCI state switch command to the first wireless node 704. The TCI state switch command may be configured to command the first wireless node 704 to switch from a current TCI state of a CSI-RS resource to a predicted TCI state (e.g., second TCI state) for the CSI-RS resource. At a seventh communication 722, the second wireless node 702 may transmit, to the first wireless node 704, the CSI-RS resource associated with the second TCI state.

### Example Methods and Techniques for Activating a TCI State without Prior Deactivation

In certain aspects, a total number of active CSI-RS resources should not exceed a reported capability of a wireless node. That is, to update TCI states for a semi-persistent (SP-CSI-RS) resource set, the network may need to first deactivate a CSI-RS resource set via a SP-CSI-RS deactivation MAC-CE, and then re-activate it using an SP-CSI-RS activation MAC-CE which carries updated TCI states. Currently, there is no definition of future TCI states regarding SP-CSI-RS resources, and the wireless node must assume that the updated TCI states in the activation MAC-CE will take immediate effect.

As discussed, several problems may arise because of this. First, there may be no time or not enough time for the wireless node to effectively refine its receive beams before actually receiving the SP-CSI-RS resources over beams associated with the updated TCI states. And second, if beam change happens frequently, the multiple MAC-CEs transmitted for deactivation and reactivation will contribute to excessive communication overhead.

Thus, in certain aspects, a TCI state may be reactivated by a MAC-CE (e.g., any of the aforementioned MAC-CE formats and configurations described above in reference to FIGS. 7 and 8) without transmitting a deactivation MAC-CE (e.g., the activation MAC-CE updating the TCI state of a first set of CSI-RSs may be transmitted independent of receiving a deactivation MAC-CE corresponding to the first set of CSI-RSs). For example, a first CSI-RS resource may be active at a wireless node, wherein the first CSI-RS resource is associated with a first TCI state. Then, without receiving a deactivation MAC-CE, the wireless node may receive, from the network node, another MAC-CE indicating the same first CSI-RS resource and associating it with a second TCI state. The wireless node may then replace the first TCI state with the second TCI state so that the first CSI-RS resource is associated with the second TCI state without having to first deactivate then reactivate the first CSI-RS resource. Because the MAC-CE used to activate the second TCI state can be any of the aforementioned MAC-CE formats and configurations discussed above, the MAC-CE may indicate a CSI-RS resource identifier or a CSI-RS resource set comprising one or more CSI-RS resource identifiers.

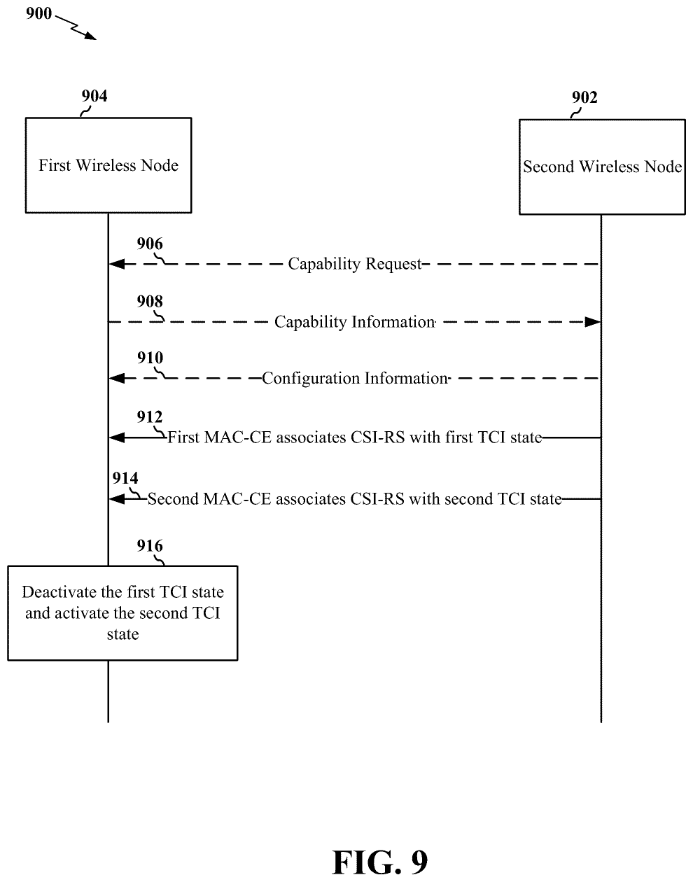

FIG. 9 is a call flow diagram illustrating example communications 900 between a first wireless node 904 (e.g., a network node 102 or a UE 104 of FIGS. 1 and 3) and a second wireless node 902 (e.g., a UE 104 or a network node 102 of FIGS. 1 and 3).

Initially, the second wireless node 902 may transmit a capability request to the first wireless node 904 in an optional first communication 906. Here, the second wireless node 902 may request information about whether the first wireless node 904 is capable of receiving an indication of one or more updated TCI states for an already active CSI-RS, and applying the updated TCI states to the CSI-RS without first receiving a deactivation command deactivating the CSI-RS and its corresponding current TCI states.

In an optional second communication 908, the first wireless node 904 may transmit an indication of its capability for receiving an indication of one or more updated TCI states for an already active CSI-RS, and applying the updated TCI states to the CSI-RS without first receiving a deactivation command deactivating the CSI-RS and its corresponding current TCI states. The second communication 908 may be transmitted to the second wireless node 902 in response to the first communication 906, or the second communication may be transmitted independent of any such communication from the second wireless node 902.

In a third communication 910, the second wireless node 902 may optionally transmit configuration information to the first wireless node 904. The configuration information may include an indication of one or more MAC-CE formats (e.g., information carried by the MAC-CE) to be used for updating the TCI state(s) of a CSI-RS. The first communication 906, second communication 908, and/or the third communication 910 may be performed via radio resource control (RRC) messaging.

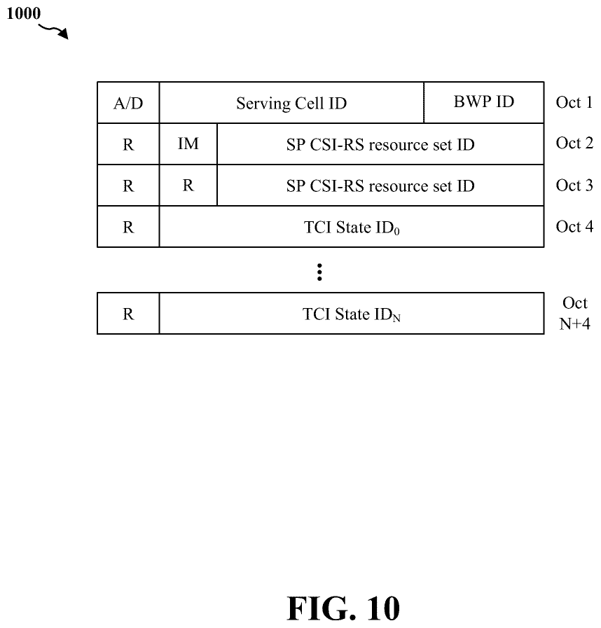

Initially, the first wireless node 904 may receive a first CSI-RS transmission from the second wireless node 902, wherein the first CSI-RS is associated with a first TCI state. Thus, the first wireless node 904 may receive the first CSI-RS via a particular beam pair. For example, at a fourth transmission 912, the second wireless node 902 may transmit a first MAC-CE configured to associate the first CSI-RS resource with the first TCI state. Thus, the first CSI-RS and the first TCI state may have been configured at the first wireless node 904 via the first MAC-CE transmission from the second wireless node 902. FIG. 10 illustrates an example format of the first MAC-CE transmission.

FIG. 10 is a block diagram illustrating an example MAC-CE 1000 format. The MAC-CE 1000 may include multiple fields, including an activate/deactivate (A/D) field, a serving cell ID, a bandwidth part (BWP) ID, reserved (R) fields, an interference measurement (IM) field, one or more SP CSI-RS resource set IDs, and one or more TCI State IDs corresponding to the identified CSI-RS resource(s).

The A/D field may be configured to indicate whether to activate or deactivate a particular SP CSI-RS and/or CSI-IM resource identified in the MAC-CE 1000 (e.g., “SP CSI-RS resource set ID” field). The A/D field may be set to “1” to indicate activation, otherwise it indicates deactivation. As noted the SP CSI-RS resource set ID field may include an index (e.g., NZP-CSI-RS-ResourceSet) for an SP NZP CSI-RS resource set to which the A/D field applies.

TCI State ID field may include a TCI State (e.g., TCI-StateId), which may be used as a quasi-colocation (QCL) source for a CSI-RS resource within the CSI-RS resource set indicated by SP CSI-RS resource set ID field. TCI State ID₀ may correspond to a TCI state for the first CSI-RS resource within the set, TCI State ID₁ may correspond to the second CSI-RS resource within the set, and so on.

Referring back to FIG. 9, the second wireless node 902 may transmit a fifth communication 914 to the first wireless node 904, wherein the fifth communication 914 includes a second MAC-CE configured to associate the first CSI-RS with a second TCI state by replacing the first TCI state. Note that an intermediary MAC-CE (e.g., MAC-CE of FIG. 10) is not required between the fourth transmission 912 and the fifth communication 914. Instead, the first wireless node 904 may treat the second MAC-CE as a implicit command to deactivate 916 one or more of the current first TCI states of the first CSI-RS and replace them with one or more second TCI states indicated in the second MAC-CE. Thus, similar to the first MAC-CE, the second MAC-CE may also include an indication of a particular CSI-RS resource set and the one or more second TCI states corresponding to the one or more CSI-RS resources in the set.

In some examples, the second MAC-CE may be the same format at the first MAC-CE illustrated in FIG. 10. In another example, the second MAC-CE may be a format that includes one or more of the aspects of the first example 800 and the second example 810 of FIG. 8. That is, the second MAC-CE may indicate a TCI state only for CSI-RS resources that are being updated. This may reduce the size of the second MAC-CE relative to the example illustrated in FIG. 10 because the second MAC-CE can leave out CSI-RS resources and CSI-RS resource sets if they have no corresponding TCI state change. Thus, a second MAC-CE that only includes a single CSI-RS resource indication and a single corresponding TCI state is possible.

In some examples, the second MAC-CE may not include a time instance, or a time window associated with the updated TCI-state. For instance, the first wireless node 904 may update the TCI state of a CSI-RS at a next applicable occasion associated with the CSI-RS resource (e.g., a slot that immediately follows the slot carrying the second MAC-CE). In some examples, the second MAC-CE may not include an uncertainty level associated with the updated TCI state. For instance, the uncertainty level may be associated with a TCI state of the second MAC-CE be considered to be 0% (e.g., 100% certain).

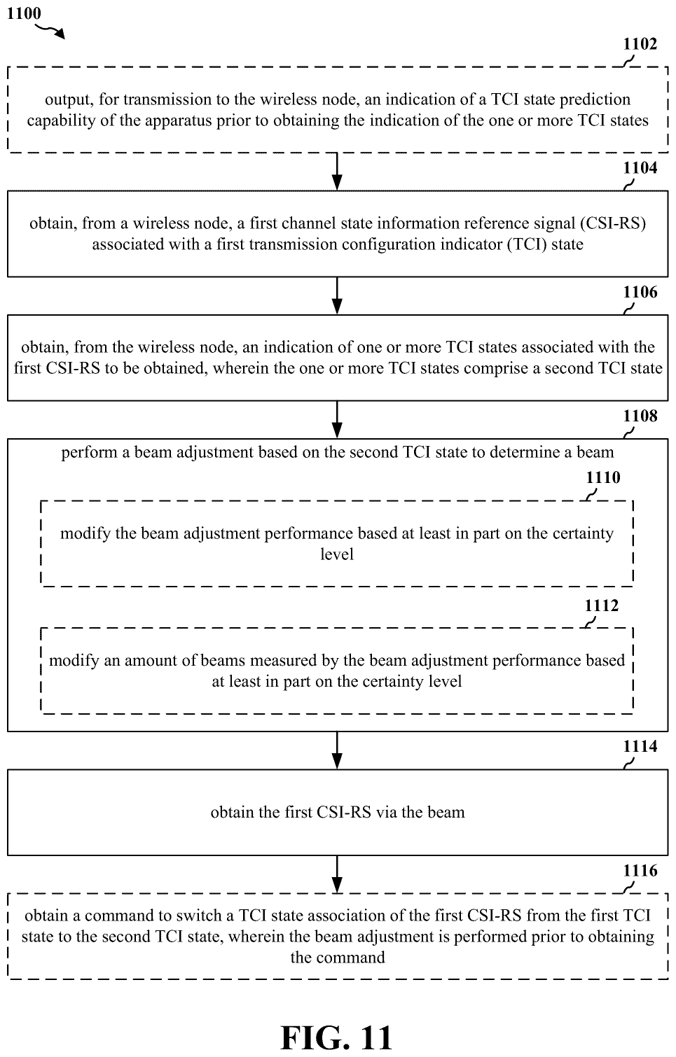

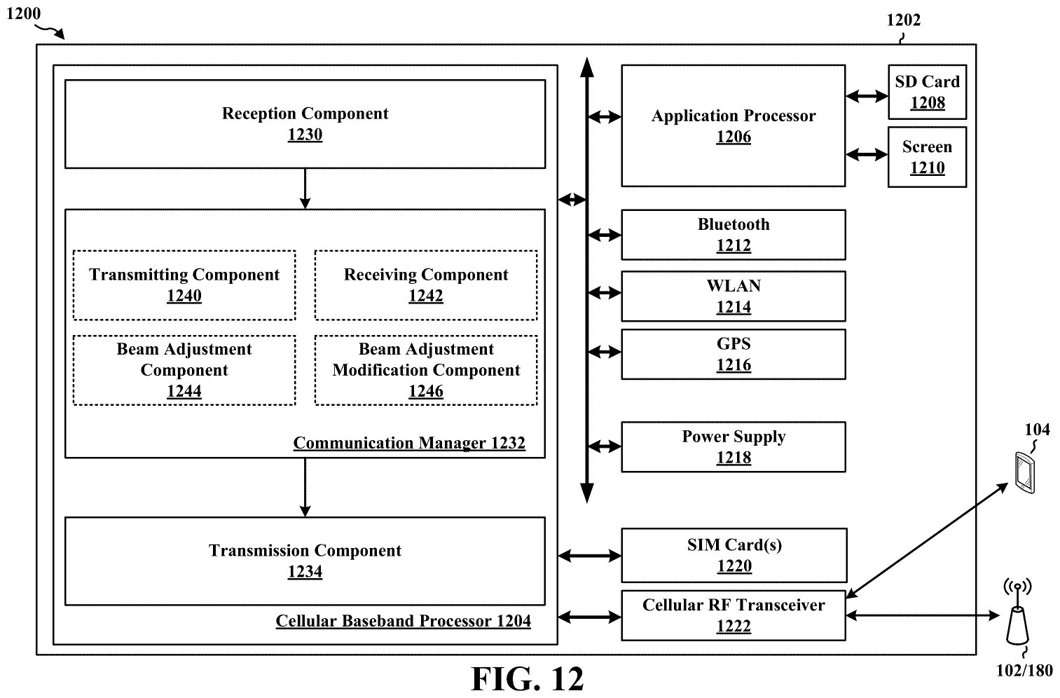

FIG. 11 is a flowchart 1100 of a method of wireless communication. The method may be performed by an apparatus (e.g., the UE 104 of FIGS. 1 and 3; or alternatively the base station 102/180 of FIGS. 1 and 3). At 1102, the apparatus may output, for transmission to the wireless node, an indication of a TCI state prediction capability of the apparatus prior to obtaining the indication of the one or more TCI states. For example, 1102 may be performed by a transmitting component 1240 of the apparatus 1202 of FIG. 12. Here, the apparatus may receive, from another wireless device, a request for information about whether the apparatus is capable of receiving an indication of one or more predicted future TCI states and/or performing receive-beam refinement operations using the future TCI states in response to the indication. The apparatus may respond to the capability request with information configured to notify the other wireless device of its capability for receiving the indication of one or more predicted future TCI states and/or performing receive-beam refinement operations using the future TCI states in response to the indication. In some examples, the apparatus may voluntarily transmit the second communication during a link establishment or any other suitable time. In some examples, the indication of the TCI state prediction capability may be transmitted via a radio resource control (RRC) message

At 1104, the apparatus may obtain, from the other wireless device, a first channel state information reference signal (CSI-RS) associated with a first transmission configuration indicator (TCI) state. For example, 1104 may be performed by a receiving component 1242 of the apparatus 1202 of FIG. 12. Here, the apparatus may receive a CSI-RS signal associated with a TCI state. The TCI state may provide QCL information indicating a first transmit beam for receiving the CSI-RS.

At 1106, the apparatus may obtain, from the wireless node, an indication of one or more TCI states associated with the first CSI-RS to be obtained, wherein the one or more TCI states comprise a second TCI state. For example, 1106 may be performed by the receiving component 1242 of the apparatus 1202 of FIG. 12. Here, the apparatus may receive an indication of one or more TCI states (e.g., second TCI state) associated with the same CSI-RS signal, wherein the one or more TCI states are predicted TCI states for a future time.

At 1108, the apparatus may perform beam adjustment based on the second TCI state to determine a beam. For example, 1108 may be performed by the beam adjustment component 1244 of the apparatus 1202 of FIG. 12. Here, the apparatus may perform a beam refinement operation to determine a beam pair for receiving the CSI-RS using a different beam determined based on the second TCI state.

At 1110, the apparatus may optionally modify the beam adjustment performance based at least in part on the certainty level. For example, 1110 may be performed by the beam adjustment modification component 1246 of the apparatus 1202 of FIG. 12. Here, the indication of one or more TCI states may further comprise an indication of a certainty level of each of the one or more TCI states predicted to define the first CSI-RS at the future time. According to the certainty or uncertainty level, the apparatus may modify the beam adjustment performance. For example, if the predicted TCI states have a high certainty level (e.g., low uncertainty level), then the apparatus may focus the beam adjustment on a particular SSB beam. However, if the predicted TCI states have a low certainty level (e.g., high uncertainty level), then the apparatus may focus the beam adjustment on a plurality of SSB beams (e.g., neighboring SSB beams). The number of SSB beams may increase as the certainty level decreases.

At 1112, the apparatus may optionally modify an amount (e.g., a number or quantity) of beams measured by the beam adjustment performance based at least in part on the certainty level. For example, 1112 may be performed by the beam adjustment modification component 1246 of the apparatus 1202 of FIG. 12. Here, the certainty level may control how many transmit beams are measured during the beam adjustment procedure. The number of transmit beams may increase as the certainty level decreases.

At 1114, the apparatus may obtain the first CSI-RS via the beam. For example, 1114 may be performed by the receiving component 1242 of the apparatus 1202 of FIG. 12. Here, the apparatus may receive the first CSI-RS via the beam determine by the beam adjustment based on the predicted TCI state.

At 1116, the apparatus may optionally obtain a command to switch a TCI state association of the first CSI-RS from the first TCI state to the second TCI state, wherein the beam adjustment is performed prior to obtaining the command. For example, 1114 may be performed by the receiving component 1242 of the apparatus 1202 of FIG. 12. Here, the apparatus may receive a command to switch from the first TCI state to the predicted second TCI state.

In certain aspects, the indication of one or more TCI states is obtained via a medium access control-control element (MAC-CE). For example, the predicted TCI state(s) may be transmitted to the apparatus via MAC-CE.

In certain aspects, the one or more TCI states further comprise a third TCI state associated with the first CSI-RS to be obtained at a future time.

In certain aspects, the indication of one or more TCI states further comprises at least one of an identifier of a CSI-RS set comprising the first CSI-RS or an identifier of the first CSI-RS.

In certain aspects, the CSI-RS set further comprises a second CSI-RS, and wherein the second TCI state is predicted to define either of the first CSI-RS or the second CSI-RS at the future time.

In certain aspects, the indication of one or more TCI states further comprises a prediction of the future time for obtaining a command to switch from the first TCI state to the second TCI state defining the first CSI-RS.

In certain aspects, the prediction of the future time is defined by a time instance or a time window, wherein the time instance is based on a predicted mean time value, and wherein the time window is based on the predicted mean time value and a standard deviation value associated with the predicted mean time value.

In certain aspects, a duration of the performed beam adjustment is based at least in part on the prediction of the future time.

In certain aspects, the prediction of the future time is indicative of a certainty level of the one or more TCI states predicted to define the first CSI-RS at the future time.

In certain aspects, the indication of one or more TCI states further comprises a prediction of the future time for each of the one or more TCI states predicted to define the first CSI-RS.

FIG. 12 is a diagram 1200 illustrating an example of a hardware implementation for an apparatus 1202. The apparatus 1202 may be implemented as a UE or as a network node (e.g., as a base station or aspect thereof). The apparatus 1202 includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 104 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., UE 104 of FIG. 3) or base station (e.g., base station 102/180 of FIG. 3) and include the aforediscussed additional modules of the apparatus 1202.

The communication manager 1232 includes a transmitting component 1240 that is configured to output, for transmission to the wireless node, an indication of a TCI state prediction capability of the apparatus prior to obtaining the indication of the one or more TCI states, e.g., as described in connection with 1102 of FIG. 11.

The communication manager 1232 further includes a receiving component 1242 is configured to obtain, from a wireless node, a first channel state information reference signal (CSI-RS) associated with a first transmission configuration indicator (TCI) state; obtain, from the wireless node, an indication of one or more TCI states associated with the first CSI-RS to be obtained, wherein the one or more TCI states comprise a second TCI state; obtain the first CSI-RS via the beam; obtain a command to switch a TCI state association of the first CSI-RS from the first TCI state to the second TCI state, wherein the beam adjustment is performed prior to obtaining the command; e.g., as described in connection with 1104, 1106, 1114, and 1116 of FIG. 11.

The communication manager 1232 further includes a beam adjustment component 1244 configured to perform a beam adjustment based on the second TCI state to determine a beam, e.g., as described in connection with 1108 of FIG. 11.

The communication manager 1232 further includes a beam adjustment modification component 1246 configured to modify the beam adjustment performance based at least in part on the certainty level; and modify an amount (e.g., a number or quantity) of beams measured by the beam adjustment performance based at least in part on the certainty level, e.g., as described in connection with 1110 and 1112 of FIG. 11.

The apparatus may include additional components that perform each of the blocks of the algorithm in the aforementioned flowchart of FIG. 11. As such, each block in FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for outputting, for transmission to the wireless node, an indication of a TCI state prediction capability of the apparatus prior to obtaining the indication of the one or more TCI states; means for obtaining, from a wireless node, a first channel state information reference signal (CSI-RS) associated with a first transmission configuration indicator (TCI) state; means for obtaining, from the wireless node, an indication of one or more TCI states associated with the first CSI-RS to be obtained, wherein the one or more TCI states comprise a second TCI state; means for performing a beam adjustment based on the second TCI state to determine a beam; means for modifying the beam adjustment performance based at least in part on the certainty level; means for modifying an amount of beams measured by the beam adjustment performance based at least in part on the certainty level; means for obtaining the first CSI-RS via the beam; and means for obtaining a command to switch a TCI state association of the first CSI-RS from the first TCI state to the second TCI state, wherein the beam adjustment is performed prior to obtaining the command.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

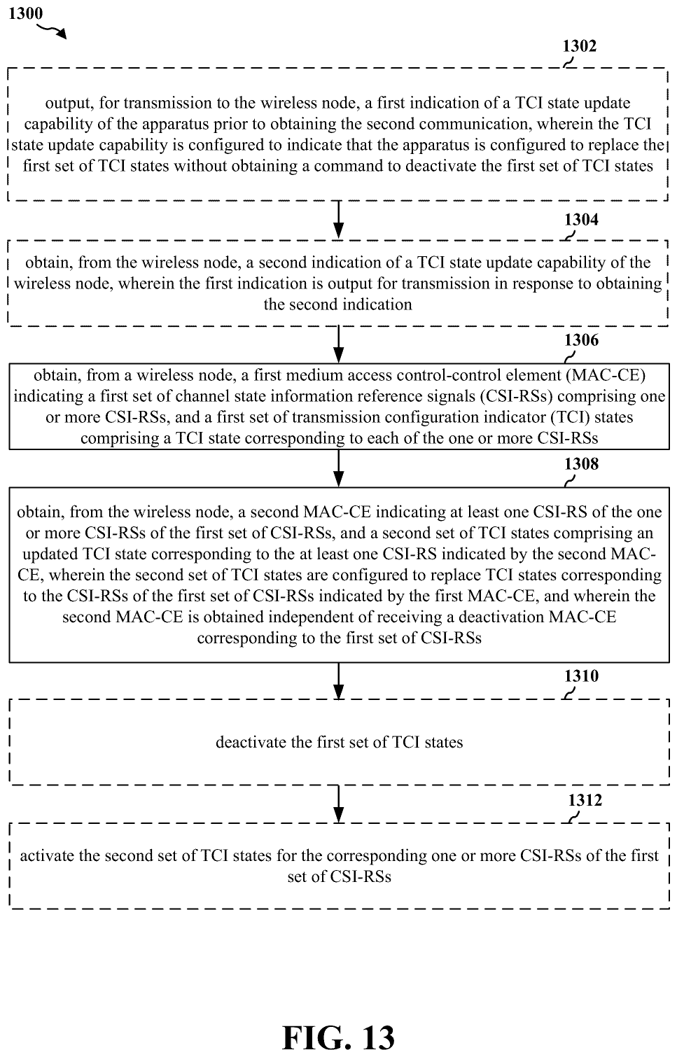

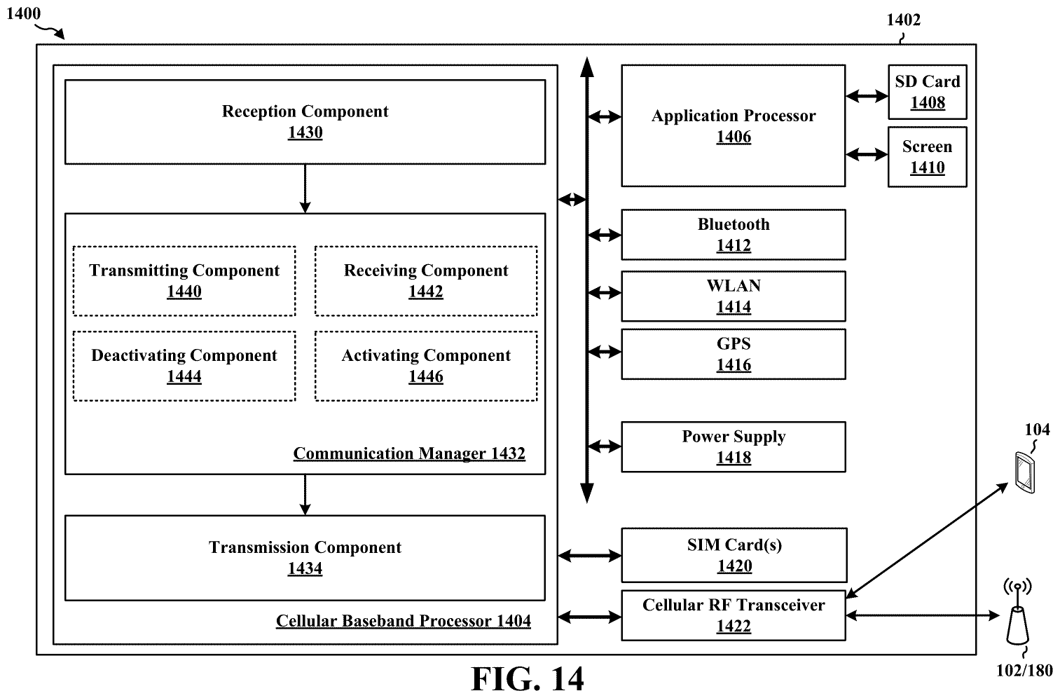

FIG. 13 is a flowchart 1300 of a method of wireless communication. The method may be performed by an apparatus (e.g., the UE 104 of FIGS. 1 and 3. At 1302, the UE may optionally output, for transmission to the wireless node, a first indication of a TCI state update capability of the apparatus prior to obtaining the second communication, wherein the TCI state update capability is configured to indicate that the apparatus is configured to replace the first set of TCI states without obtaining a command to deactivate the first set of TCI states. For example, 1302 may be performed by a transmitting component 1440 of FIG. 14. Here, the UE may provide a network node with an indication of the UE's capability to apply an updated TCI state to an active CSI-RS without first deactivating the CSI-RS.

At 1304, the UE may optionally obtain, from the wireless node, a second indication of a TCI state update capability of the wireless node, wherein the first indication is output for transmission in response to obtaining the second indication. For example, 1304 may be performed by a receiving component 1442 of FIG. 14. Here, the UE may receive a capability indication from the network node indicating that the network node is also capable of transmitting a TCI state update to a CSI-RS without first transmitting a deactivation command (e.g., MAC-CE) to the UE. In some examples, the capability indication from the network node may be received in response to the capability indication transmitted at 1302.

At 1306, the UE may obtain, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. For example, 1306 may be performed by the receiving component 1442 of FIG. 14. Here, the network node may transmit an indication of a particular CSI-RS resource and a corresponding TCI state of that resource to the UE. The UE may use the indication to determine a beam for receiving the CSI-RS resource based on the TCI state.

At 1308, the UE may obtain, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs. For example, 1308 may be performed by the receiving component 1442 of FIG. 14. Here, the network node may transmit a second indication identifying the same CSI-RS resource and another associated TCI state. This TCI state may be different from the TCI state obtained at 1306. In this example, no command to deactivate the CSI-RS is transmitted by the network node or received by the UE. Instead, the UE is configured to automatically update the TCI state received at 1306 with the TCI state received in the second indication.

At 1310, the UE may deactivate the first set of TCI states. For example, 1310 may be performed by the deactivating component 1444 of FIG. 14. Here, the UE may replace a current TCI state with an updated TCI state received at 1308. In some examples, that includes deactivating the current TCI state for the active CSI-RS prior to replacing it with the updated TCI state.

At 1312, the UE may activate the second set of TCI states for the corresponding one or more CSI-RSs of the first set of CSI-RSs. For example, 1312 may be performed by the activating component 1446 of FIG. 14. Here, the UE may replace the current TCI state with the updated TCI state by activating the updated TCI state for the CSI-RS after deactivating the current TCI state.

In certain aspects, the second MAC-CE indicates the at least one CSI-RS of the one or more CSI-RSs of the first set of CSI-RSs via one or more of: a CSI-RS resource set identifier (ID), or a CSI-RS resource ID.

In certain aspects, the first MAC-CE is configured to activate the first set of CSI-RSs at the apparatus.

In certain aspects, the second MAC-CE does not increase an amount of activated CSI-RSs at the apparatus.

In certain aspects, the second MAC-CE indicates each of the one or more CSI-RSs of the first set of CSI-RSs, and wherein the second set of TCI states comprises the updated TCI state corresponding to each of the one or more CSI-RSs.

In certain aspects, the second MAC-CE indicates only a CSI-RS of the one or more CSI-RSs having a corresponding updated TCI state.

FIG. 14 is a diagram 1400 illustrating an example of a hardware implementation for an apparatus 1402. The apparatus 1402 may be implemented as a UE. The apparatus 1402 includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 104 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., UE 104 of FIG. 3) and include the aforediscussed additional modules of the apparatus 1402.

The communication manager 1432 includes a transmitting component 1440 configured to output, for transmission to the wireless node, a first indication of a TCI state update capability of the apparatus prior to obtaining the second communication, wherein the TCI state update capability is configured to indicate that the apparatus is configured to replace the first set of TCI states without obtaining a command to deactivate the first set of TCI states; e.g., as described in connection with 1302 of FIG. 13.

The communication manager 1432 further includes a receiving component 1442 configured to obtain, from the wireless node, a second indication of a TCI state update capability of the wireless node, wherein the first indication is output for transmission in response to obtaining the second indication; obtain, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and obtain, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs; e.g., as described in connection with 1304, 1306, and 1308.

The communication manager 1432 further includes a deactivating component 1444 configured to deactivate the first set of TCI states; e.g., as described in connection with 1310 of FIG. 13.

The communication manager 1432 further includes an activating component 1446 configured to activate the second set of TCI states for the corresponding one or more CSI-RSs of the first set of CSI-RSs; e.g., as described in connection with 1312 of FIG. 13.

The apparatus may include additional components that perform each of the blocks of the algorithm in the aforementioned flowchart of FIG. 13. As such, each block in FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the baseband unit 1404, includes means for outputting, for transmission to the wireless node, a first indication of a TCI state update capability of the apparatus prior to obtaining the second communication, wherein the TCI state update capability is configured to indicate that the apparatus is configured to replace the first set of TCI states without obtaining a command to deactivate the first set of TCI states; means for obtaining, from the wireless node, a second indication of a TCI state update capability of the wireless node, wherein the first indication is output for transmission in response to obtaining the second indication; means for obtaining, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; means for obtaining, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs; means for deactivating the first set of TCI states; and means for activating the second set of TCI states for the corresponding one or more CSI-RSs of the first set of CSI-RSs.

The aforementioned means may be one or more of the aforementioned components of the apparatus 1402 configured to perform the functions recited by the aforementioned means. As described supra, the apparatus 1402 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

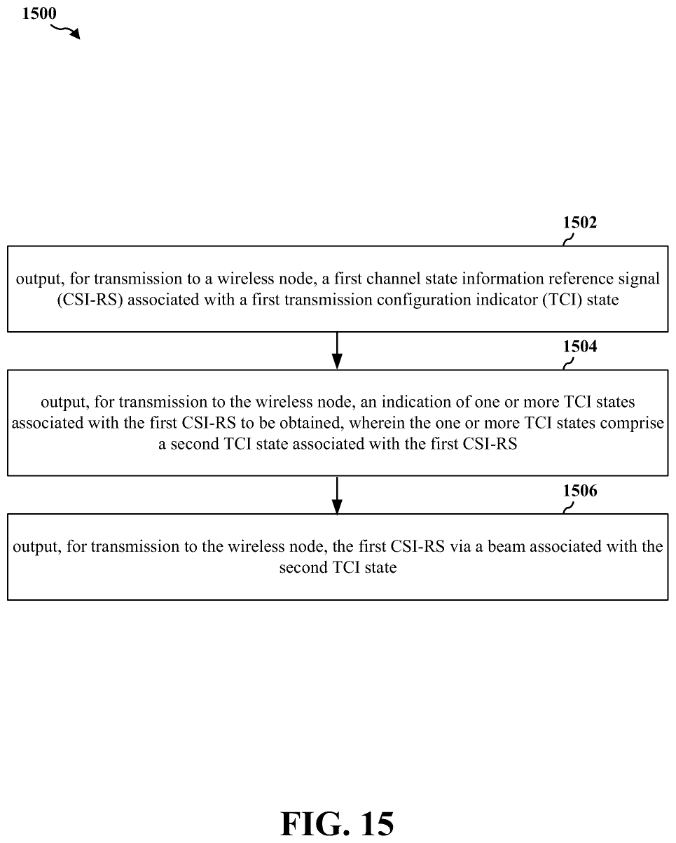

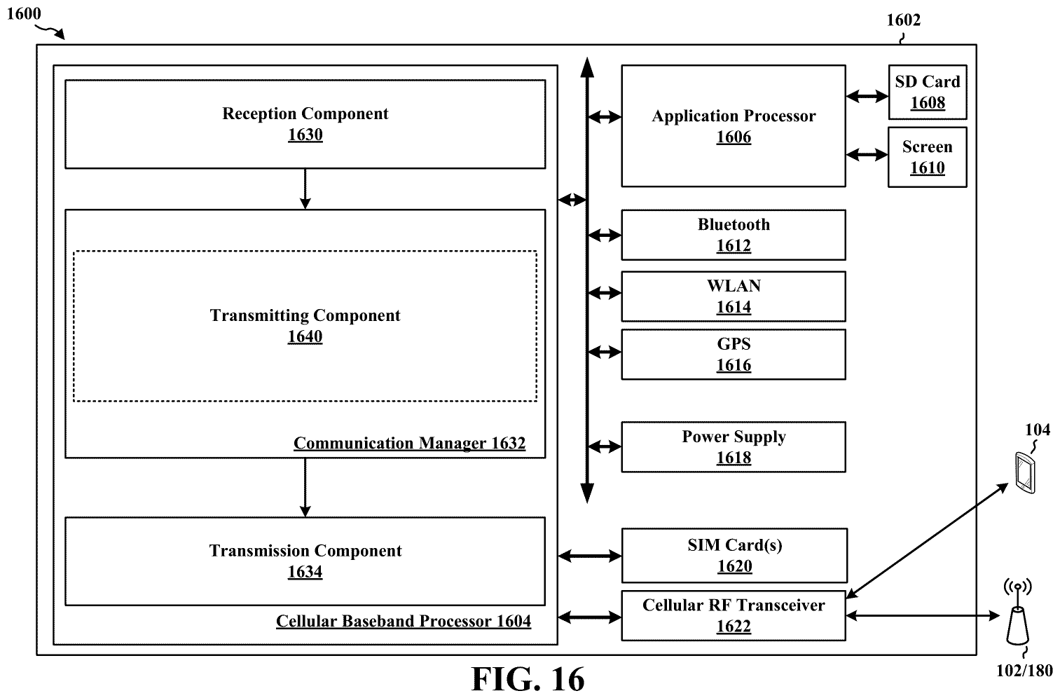

FIG. 15 is a flowchart 1500 of a method of wireless communication. The method may be performed by an apparatus (e.g., the UE 104 of FIGS. 1 and 3; or alternatively the base station 102/180 of FIGS. 1 and 3). At 1502, the apparatus may output, for transmission to a wireless node, a first channel state information reference signal (CSI-RS) associated with a first transmission configuration indicator (TCI) state. For example, 1502 may be performed by a transmitting component 1640 of the apparatus 1602 of FIG. 16. Here, the apparatus may receive a CSI-RS signal associated with a TCI state. The TCI state may provide QCL information indicating a first transmit beam for receiving the CSI-RS.

At 1504, the apparatus may output, for transmission to the wireless node, an indication of one or more TCI states associated with the first CSI-RS to be obtained, wherein the one or more TCI states comprise a second TCI state associated with the first CSI-RS. For example, 1504 may be performed by a transmitting component 1640 of the apparatus 1602 of FIG. 16. Here, the apparatus may transmit an indication of one or more TCI states (e.g., second TCI state) associated with the same CSI-RS signal, wherein the one or more TCI states are predicted TCI states for a future time.

At 1506, the apparatus may output, for transmission to the wireless node, the first CSI-RS via a beam associated with the second TCI state. For example, 1506 may be performed by a transmitting component 1640 of the apparatus 1602 of FIG. 16. Here, the apparatus may transmit the CSI-RS, where the CSI-RS is now associated with a predicted TCI state. In other words, the CSI-RS may now be transmitted over a different transmit beam.

FIG. 16 is a diagram 1600 illustrating an example of a hardware implementation for an apparatus 1602. The apparatus 1602 may be implemented as a UE or as a network node (e.g., as a base station or aspect thereof). The apparatus 1602 includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 104 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., UE 104 of FIG. 3) or base station (e.g., base station 102/180 of FIG. 3) and include the aforediscussed additional modules of the apparatus 1602.

The communication manager 1632 includes a transmitting component 1640 that is configured to output, for transmission to a wireless node, a first channel state information reference signal (CSI-RS) associated with a first transmission configuration indicator (TCI) state; output, for transmission to the wireless node, an indication of one or more TCI states associated with the first CSI-RS to be obtained, wherein the one or more TCI states comprise a second TCI state associated with the first CSI-RS; and output, for transmission to the wireless node, the first CSI-RS via a beam associated with the second TCI state; e.g., as described in connection with 1502, 1504, and 1506 of FIG. 15.

The apparatus may include additional components that perform each of the blocks of the algorithm in the aforementioned flowchart of FIG. 15. As such, each block in FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for outputting, for transmission to a wireless node, a first channel state information reference signal (CSI-RS) associated with a first transmission configuration indicator (TCI) state; means for outputting, for transmission to the wireless node, an indication of one or more TCI states associated with the first CSI-RS to be obtained, wherein the one or more TCI states comprise a second TCI state associated with the first CSI-RS; and means for outputting, for transmission to the wireless node, the first CSI-RS via a beam associated with the second TCI state.

The aforementioned means may be one or more of the aforementioned components of the apparatus 1602 configured to perform the functions recited by the aforementioned means. As described supra, the apparatus 1602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

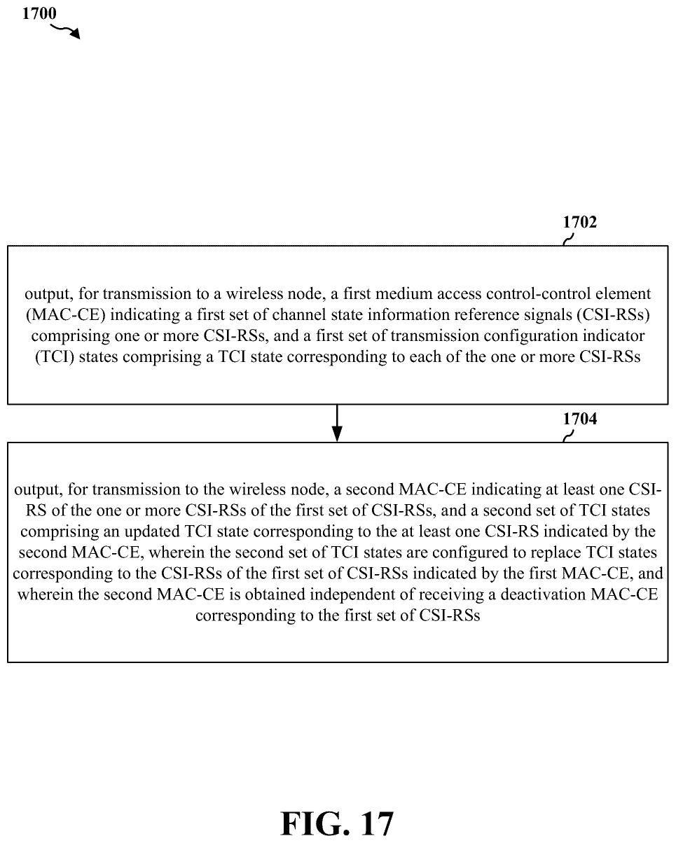

FIG. 17 is a flowchart 1700 of a method of wireless communication. The method may be performed by a base station or network node (e.g., the base station 102/180; the apparatus 1802). At 1702, the base station may output, for transmission to a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs. For example, 1702 may be performed by a transmitting component 1840. Here, the base station may transmit an indication of a particular CSI-RS resource and a corresponding TCI state of that resource to the UE. The UE may use the indication to determine a beam for receiving the CSI-RS resource based on the TCI state.

At 1704, the base station may output, for transmission to the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs. For example, 1704 may be performed by the transmitting component 1840. Here, the network node may transmit a second indication identifying the same CSI-RS resource and another associated TCI state. This TCI state may be different from the TCI state obtained at 1306. In this example, no command to deactivate the CSI-RS is transmitted by the network node or received by the UE. Instead, the UE is configured to automatically update the TCI state received at 1306 with the TCI state received in the second indication.

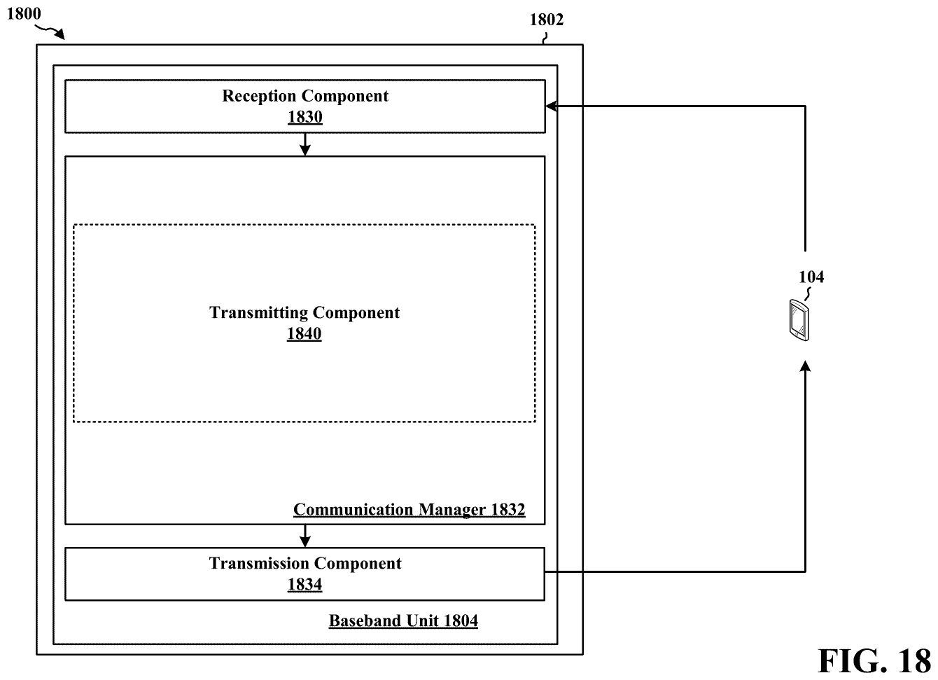

FIG. 18 is a diagram 1800 illustrating an example of a hardware implementation for an apparatus 1802. The apparatus 1802 is a BS and includes a baseband unit 1804. The baseband unit 1804 may communicate through a cellular RF transceiver with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the BS 102/180 and may include the memory 376 and/or at least one of the TX processor 316, the RX processor 370, and the controller/processor 375.

The communication manager 1832 includes a transmitting component 1840 configured to output, for transmission to a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and output, for transmission to the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs; e.g., as described in connection with 1702 and 1704 of FIG. 17.

The apparatus may include additional components that perform each of the blocks of the algorithm in the aforementioned flowchart of FIG. 17. As such, each block in FIG. 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes means for outputting, for transmission to a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and means for outputting, for transmission to the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

The aforementioned means may be one or more of the aforementioned components of the apparatus 1802 configured to perform the functions recited by the aforementioned means. As described supra, the apparatus 1802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### Additional Considerations

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is method for wireless communications at a first wireless node, comprising: obtaining, from a second wireless node, a first channel state information reference signal (CSI-RS) associated with a first transmission configuration indicator (TCI) state; obtaining, from the second wireless node, an indication of one or more TCI states associated with the first CSI-RS to be obtained, wherein the one or more TCI states comprise a second TCI state; performing a beam adjustment based on the second TCI state to determine a beam; and obtaining the first CSI-RS via the beam.

Example 2 is the example of method 1, wherein the indication of one or more TCI states is obtained via a medium access control-control element (MAC-CE).

Example 3 is the method of any of examples 1 and 2, further comprising: outputting, for transmission to the second wireless node, an indication of a TCI state prediction capability of the first wireless node prior to obtaining the indication of the one or more TCI states.

Example 4 is the method of any of examples 1-3, wherein the one or more TCI states further comprise a third TCI state associated with the first CSI-RS to be obtained at a future time.

Example 5 is the method of any of examples 1-4, further comprising: obtaining a command to switch a TCI state association of the first CSI-RS from the first TCI state to the second TCI state, wherein the beam adjustment is performed prior to obtaining the command.

Example 6 is the method of any of examples 1-5, wherein the indication of one or more TCI states further comprises at least one of an identifier of a CSI-RS set comprising the first CSI-RS or an identifier of the first CSI-RS.

Example 7 is the method of example 6, wherein the CSI-RS set further comprises a second CSI-RS, and wherein the second TCI state is associated with either of the first CSI-RS or the second CSI-RS to be obtained.

Example 8 is the method of any of examples 1-7, wherein the indication of one or more TCI states further comprises a prediction of a future time for obtaining a command to switch from the first TCI state to the second TCI state associated with the first CSI-RS.

Example 9 is the method of example 8, wherein the prediction of the future time is defined by a time instance or a time window, wherein the time instance is based on a predicted mean time value, and wherein the time window is based on the predicted mean time value and a standard deviation value associated with the predicted mean time value.

Example 10 is the method of any of examples 8 and 9, wherein a duration of the performed beam adjustment is based at least in part on the prediction of the future time.

Example 11 is the method of any of examples 8-10, wherein the prediction of the future time is indicative of a certainty level of the one or more TCI states predicted to be associated with the first CSI-RS at the future time.

Example 12 is the method of any of examples 1-11, wherein the indication of one or more TCI states further comprises a prediction of a future time for each of the one or more TCI states predicted to be associated with the first CSI-RS.

Example 13 is the method of any of examples 1-12, wherein the indication of one or more TCI states further comprises an indication of a certainty level of each of the one or more TCI states associated with the first CSI-RS to be obtained, and wherein the method further comprises: modifying the beam adjustment performance based at least in part on the certainty level.

Examples 14 is the method of example 13, further comprising: modifying an amount of beams measured by the beam adjustment performance based at least in part on the certainty level.

Example 15 is the method of any of examples 13 and 14, further comprising: outputting, for transmission to the second wireless node, at least one of a confirmation or an indication of the modification of the beam adjustment performance.

Example 16 is a method for wireless communications at a user equipment (UE), comprising: obtaining, from a network node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and obtaining, from the network node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Example 17 is the method of example 16, wherein the second MAC-CE indicates the at least one CSI-RS of the one or more CSI-RSs of the first set of CSI-RSs via one or more of: a CSI-RS resource set identifier (ID), or a CSI-RS resource ID.

Example 18 is the method of any of examples 16 and 17, further comprising: deactivating the first set of TCI states; and activating the second set of TCI states for the corresponding one or more CSI-RSs of the first set of CSI-RSs.

Example 19 is the method of any of examples 16-18, wherein the first MAC-CE is configured to activate the first set of CSI-RSs at the apparatus.

Example 20 is the method of example 19, wherein the second MAC-CE does not increase an amount of activated CSI-RSs at the apparatus.

Example 21 is the method of any of examples 16-20, wherein the second MAC-CE indicates each of the one or more CSI-RSs of the first set of CSI-RSs, and wherein the second set of TCI states comprises the updated TCI state corresponding to each of the one or more CSI-RSs.

Example 22 is the method of any of examples 16-21, wherein the second MAC-CE indicates only a CSI-RS of the one or more CSI-RSs having a corresponding updated TCI state.

Example 23 is the method of any of examples 16-22, further comprising: outputting, for transmission to the network node, a first indication of a TCI state update capability of the apparatus prior to obtaining the second communication, wherein the TCI state update capability is configured to indicate that the apparatus is configured to replace the first set of TCI states without obtaining a command to deactivate the first set of TCI states.

Example 24 is the method of example 23, further comprising: obtaining, from the network node, a second indication of a TCI state update capability of the network node, wherein the first indication is output for transmission in response to obtaining the second indication.

Example 25 is a method for wireless communications at a user equipment (UE), comprising: outputting, for transmission to a network node, a first channel state information reference signal (CSI-RS) associated with a first transmission configuration indicator (TCI) state; outputting, for transmission to the network node, an indication of one or more TCI states associated with the first CSI-RS to be obtained, wherein the one or more TCI states comprise a second TCI state associated with the first CSI-RS; and outputting, for transmission to the second wireless node, the first CSI-RS via a beam associated with the second TCI state.

Example 26 is a method for wireless communications at a network node, comprising: outputting, for transmission to a user equipment (UE), a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and outputting, for transmission to the UE, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

Example 27 is a user equipment (UE), comprising: a transceiver; a memory comprising instructions; and one or more processors configured to execute the instructions to cause the UE to perform a method in accordance with any one of examples 1-15, wherein the transceiver is configured to: receive, from a network node, the first CSI-RS; receive, from the network node, the indication of one or more TCI states; and receive, from the network node, the first CSI-RS via the beam.

Example 28 is a network node, comprising: a transceiver; a memory comprising instructions; and one or more processors configured to execute the instructions to cause the network node to perform a method in accordance with any one of examples 1-15, wherein the transceiver is configured to: receive, from a UE, the first CSI-RS; receive, from the UE, the indication of one or more TCI states; and receive, from the UE, the first CSI-RS via the beam.

Example 29 is a user equipment (UE), comprising: a transceiver; a memory comprising instructions; and one or more processors configured to execute the instructions and cause the UE to perform a method in accordance with any one of examples 16-24, wherein the transceiver is configured to: receive the first MAC-CE; and receive the second MAC-CE.

Example 30 is a user equipment (UE), comprising: a transceiver; a memory comprising instructions; and one or more processors configured to execute the instructions to cause the UE to perform a method in accordance with example 25, wherein the transceiver is configured to: transmit the first CSI-RS; transmit the indication of one or more TCI states; and transmit the first CSI-RS via the beam.

Example 31 is a network node, comprising: a transceiver; a memory comprising instructions; and one or more processors configured to execute the instructions to cause the network node to perform a method in accordance with example 25, wherein the transceiver is configured to: transmit the first CSI-RS; transmit the indication of one or more TCI states; and transmit the first CSI-RS via the beam.

Example 32 is a network node, comprising: a transceiver; a memory comprising instructions; and one or more processors configured to execute the instructions and cause the network node to perform a method in accordance with example 26, wherein the transceiver is configured to: transmit the first MAC-CE; and transmit the second MAC-CE.

Example 33 is an apparatus for wireless communications, comprising means for performing a method in accordance with any one of examples 1-15.

Example 34 is an apparatus for wireless communications, comprising means for performing a method in accordance with any one of examples 16-24.

Example 35 is an apparatus for wireless communications, comprising means for performing a method in accordance with example 25.

Example 36 is an apparatus for wireless communications, comprising means for performing a method in accordance with example 26.

Example 37 is a non-transitory computer-readable medium comprising instructions that, when executed by an apparatus, cause the apparatus to perform a method in accordance with any one of examples 1-15.

Example 38 is a non-transitory computer-readable medium comprising instructions that, when executed by an apparatus, cause the apparatus to perform a method in accordance with any one of examples 16-24.

Example 39 is a non-transitory computer-readable medium comprising instructions that, when executed by an apparatus, cause the apparatus to perform a method in accordance with example 25.

Example 40 is a non-transitory computer-readable medium comprising instructions that, when executed by an apparatus, cause the apparatus to perform a method in accordance with example 26.

Example 41 is an apparatus for wireless communications, comprising: a memory comprising instructions; and one or more processors configured to execute the instructions to cause the apparatus to perform a method in accordance with any one of examples 1-15.

Example 42 is an apparatus for wireless communications, comprising: a memory comprising instructions; and one or more processors configured to execute the instructions to cause the apparatus to perform a method in accordance with any one of examples 16-24.

Example 43 is an apparatus for wireless communications, comprising: a memory comprising instructions; and one or more processors configured to execute the instructions to cause the apparatus to perform a method in accordance with example 25.

Example 44 is an apparatus for wireless communications, comprising: a memory comprising instructions; and one or more processors configured to execute the instructions to cause the apparatus to perform a method in accordance with example 26.

1. An apparatus for wireless communications, comprising:
a memory comprising instructions; and
one or more processors configured to execute the instructions and cause the apparatus to:
obtain, from a wireless node, a first channel state information reference signal (CSI-RS) associated with a first transmission configuration indicator (TCI) state;
obtain, from the wireless node, an indication of one or more TCI states associated with the first CSI-RS to be obtained, wherein the one or more TCI states comprise a second TCI state;
perform a beam adjustment based on the second TCI state to determine a beam; and
obtain the first CSI-RS via the beam.

2. The apparatus of claim 1, wherein the indication of one or more TCI states is obtained via a medium access control-control element (MAC-CE).

3. The apparatus of claim 1, wherein the one or more processors are further configured to cause the apparatus to:
output, for transmission to the wireless node, an indication of a TCI state prediction capability of the apparatus prior to obtaining the indication of the one or more TCI states.

4. The apparatus of claim 1, wherein the one or more TCI states further comprise a third TCI state associated with the first CSI-RS to be obtained at a future time.

5. The apparatus of claim 1, wherein the one or more processors are further configured to cause the apparatus to:
obtain a command to switch a TCI state association of the first CSI-RS from the first TCI state to the second TCI state, wherein the beam adjustment is performed prior to obtaining the command.

6. The apparatus of claim 1, wherein the indication of one or more TCI states further comprises at least one of an identifier of a CSI-RS set comprising the first CSI-RS or an identifier of the first CSI-RS.

7. The apparatus of claim 6, wherein the CSI-RS set further comprises a second CSI-RS, and wherein the second TCI state is associated with either of the first CSI-RS or the second CSI-RS to be obtained.

8. The apparatus of claim 1, wherein the indication of one or more TCI states further comprises a prediction of a future time for obtaining a command to switch from the first TCI state to the second TCI state associated with the first CSI-RS.

9. The apparatus of claim 8, wherein the prediction of the future time is defined by a time instance or a time window, wherein the time instance is based on a predicted mean time value, and wherein the time window is based on the predicted mean time value and a standard deviation value associated with the predicted mean time value.

10. The apparatus of claim 8, wherein a duration of the performed beam adjustment is based at least in part on the prediction of the future time.

11. The apparatus of claim 8, wherein the prediction of the future time is indicative of a certainty level of the one or more TCI states predicted to be associated with the first CSI-RS at the future time.

12. The apparatus of claim 1, wherein the indication of one or more TCI states further comprises a prediction of a future time for each of the one or more TCI states predicted to be associated with the first CSI-RS.

13. The apparatus of claim 1, wherein the indication of one or more TCI states further comprises an indication of a certainty level of each of the one or more TCI states associated with the first CSI-RS to be obtained, and wherein the one or more processors are further configured to cause the apparatus to:
modify the beam adjustment performance based at least in part on the certainty level.

14. The apparatus of claim 13, wherein the one or more processors are further configured to cause the apparatus to:
modify an amount of beams measured by the beam adjustment performance based at least in part on the certainty level.

15. The apparatus of claim 13, wherein the one or more processors are further configured to cause the apparatus to:
output, for transmission to the wireless node, at least one of a confirmation or an indication of the modification of the beam adjustment performance.

16. The apparatus of claim 1, further comprising a transceiver configured to:
receive the first CSI-RS; and
receive the indication of one or more TCI states associated with the first CSI-RS to be obtained, wherein the apparatus is configured as a user equipment (UE) or a network node.

17. An apparatus for wireless communications, comprising:
a memory comprising instructions; and
one or more processors configured to execute the instructions and cause the apparatus to:
obtain, from a wireless node, a first medium access control-control element (MAC-CE) indicating a first set of channel state information reference signals (CSI-RSs) comprising one or more CSI-RSs, and a first set of transmission configuration indicator (TCI) states comprising a TCI state corresponding to each of the one or more CSI-RSs; and
obtain, from the wireless node, a second MAC-CE indicating at least one CSI-RS of the one or more CSI-RSs of the first set of CSI-RSs, and a second set of TCI states comprising an updated TCI state corresponding to the at least one CSI-RS indicated by the second MAC-CE, wherein the second set of TCI states are configured to replace TCI states corresponding to the CSI-RSs of the first set of CSI-RSs indicated by the first MAC-CE, and wherein the second MAC-CE is obtained independent of receiving a deactivation MAC-CE corresponding to the first set of CSI-RSs.

18. The apparatus of claim 17, wherein the second MAC-CE indicates the at least one CSI-RS of the one or more CSI-RSs of the first set of CSI-RSs via one or more of:
a CSI-RS resource set identifier (ID), or
a CSI-RS resource ID.

19. The apparatus of claim 17, wherein the one or more processors are further configured to cause the apparatus to:
deactivate the first set of TCI states; and
activate the second set of TCI states for the corresponding one or more CSI-RSs of the first set of CSI-RSs.

20. The apparatus of claim 17, wherein the first MAC-CE is configured to activate the first set of CSI-RSs at the apparatus.

21. The apparatus of claim 20, wherein the second MAC-CE does not increase an amount of activated CSI-RSs at the apparatus.

22. The apparatus of claim 17, wherein the second MAC-CE indicates each of the one or more CSI-RSs of the first set of CSI-RSs, and wherein the second set of TCI states comprises the updated TCI state corresponding to each of the one or more CSI-RSs.

23. The apparatus of claim 17, wherein the second MAC-CE indicates only a CSI-RS of the one or more CSI-RSs having a corresponding updated TCI state.

24. The apparatus of claim 17, wherein the one or more processors are further configured to cause the apparatus to:
output, for transmission to the wireless node, a first indication of a TCI state update capability of the apparatus prior to obtaining the second communication, wherein the TCI state update capability is configured to indicate that the apparatus is configured to replace the first set of TCI states without obtaining a command to deactivate the first set of TCI states.

25. The apparatus of claim 24, wherein the one or more processors are further configured to cause the apparatus to:
obtain, from the wireless node, a second indication of a TCI state update capability of the wireless node, wherein the first indication is output for transmission in response to obtaining the second indication.

26. The apparatus of claim 17, further comprising a transceiver configured to:
receive the first communication; and
receive the second communication, wherein the apparatus is configured as a user equipment (UE).

27. An apparatus for wireless communications, comprising:
a memory comprising instructions; and
one or more processors configured to execute the instructions and cause the apparatus to:
output, for transmission to a wireless node, a first channel state information reference signal (CSI-RS) associated with a first transmission configuration indicator (TCI) state;
output, for transmission to the wireless node, an indication of one or more TCI states associated with the first CSI-RS to be obtained, wherein the one or more TCI states comprise a second TCI state associated with the first CSI-RS; and
output, for transmission to the wireless node, the first CSI-RS via a beam associated with the second TCI state.

28. (canceled)

29. (canceled)

30. (canceled)
